(19) United States
(12) Patent Application Publication
(10) Pub. No.: US 2015/0207831 A1
(43) Pub. Date: Jul. 23, 2015

(54) APPARATUS AND METHOD FOR USER COLLABORATION

(71) Applicants: Denise Elizabeth Gaspari, Burlington (CA); Natalie Anne Taylor, Oakville (CA); Luigi Gaspari, Burlington (CA)

(72) Inventors: Denise Elizabeth Gaspari, Burlington (CA); Natalie Anne Taylor, Oakville (CA)

(21) Appl. No.: 14/158,382

(22) Filed: Jan. 17, 2014

(51) Int. Cl. H04L 29/06; G06F 17/30

(52) U.S. Cl. CPC H04L 65/403; G06F 17/30115

(57) ABSTRACT

An apparatus for user collaboration includes a data processing system configured to interface with an input device, an output device, and a network connection. The data processing system includes a processor assembly, and a non-transitory machine-readable storage medium operatively coupled to the processor assembly, and tangibly embodying: an electronic file, and a set of processor-executable instructions including a collaboration program. The collaboration program is configured to display a user interface via the output device, and the user interface is configured to display, at least in part, the output of a file-manipulation program via the output device. The file-manipulation program is configured to manipulate the electronic file. The collaboration program is also configured to manipulate the user interface in such a way that the user interface displays a collaboration-initiation field to the user via the output device.

### TECHNICAL FIELD

The present invention generally relates to an apparatus and a method for user collaboration; more specifically, the present invention relates to an apparatus and a method for online user collaboration between members of a collaborative group.

### BACKGROUND

Collaboration is defined as the action of working with someone to produce something, to perform a task, and to achieve shared goals. It may be a recursive process where two or more people or organizations work together to realize shared goals by sharing knowledge, and by learning and building consensus. Collaboration requires individuals to work together in a coordinated fashion, towards a common goal. Accomplishing the goal is the primary purpose for bringing the team together.

Collaborative software is a software application operated on a data processing system, and is configured to help people involved in a common task achieve goals. Collaborative software transforms the way documents (and rich media) are shared to enable more effective team collaboration. Collaborative software helps facilitate action-oriented teams working together over geographic distances by providing tools that aid communication, collaboration and the process of problem solving.

Usage of collaborative software in the workspace establishes a collaborative work environment (CWE) between collaborative members (users). A collaborative working environment supports people in both their individual and cooperative work thus giving birth to a new class of professionals, e-professionals, who can work together irrespective of their geographical location.

Collaborative software relates to the notion of collaborative work systems, which are conceived as any form of human organization that emerges any time that collaboration takes place, whether it is formal or informal, intentional or unintentional. Collaborative software pertains to the technological elements within a computer (a data processing system) configured to support user collaboration for amending the contents of an electronic file.

### SUMMARY

Known software programs configured to facilitate virtual meetings are not as efficient for on-line user collaboration.

A problem associated with known word-processing software was identified. The known word-processing software implements (uses) an amendment tracking tool that is configured to track amendments made to the contents of an electronic file. The tracking tool allows the user to make and view tracked changes and/or insert comments while the user edits or amends the contents of an electronic file (an electronic document). However, for the case where many reviewers (collaborators) are involved in the review of the electronic file, then each reviewer may provide their own amendments to the document; however, the effort required for one or more reviewers (collaborators) to review, to make the changes to the electronic file, to keep track of the changes made by various users (collaborators), and to assure that reviewers have access to the most current and up-to-date version of the electronic file represents a large burden, since further reviews would likely be needed until each member of the collaboration group is in agreement with the final edited version of the electronic file.

In order to mitigate, at least in part, the problem(s) identified above, in accordance with an aspect of the present invention, there is provided an apparatus and a method for user collaboration.

The apparatus is for user collaboration, and the apparatus includes a data processing system configured to interface with an input device, an output device, and a network connection. The data processing system includes a processor assembly, and a non-transitory machine-readable storage medium operatively coupled to the processor assembly, and tangibly embodying: an electronic file, and a set of processor-executable instructions including a collaboration program. The collaboration program is configured to display a user interface via the output device, and the user interface is configured to display, at least in part, the output of a file-manipulation program via the output device (the file-manipulation program is configured to manipulate the electronic file). The collaboration program is also configured to manipulate the user interface in such a way that the user interface displays a collaboration-initiation field to the user via the output device.

The method is for user collaboration, and the method includes displaying a user interface via an output device of a data processing system, and the user interface is configured to display, at least in part, the output of a file-manipulation program via the output device, the file-manipulation program is configured to manipulate an electronic file. The method also includes manipulating the user interface in such a way that the user interface displays a collaboration-initiation field to the user via the output device.

The collaboration program may be further configured to be integrated with the file-manipulation program, and the file-manipulation program is configured to facilitate user amendment of the electronic file in response to user commands received via the input device of the data processing system. This option presents an advantage for the users in that the users merely need to operate one software program, and not two software programs (one program for setting up the collaboration communication session, and the other program for setting up the file manipulation).

The collaboration program may be further configured to display an online user collaboration session from within the electronic file as displayed by the file-manipulation program to the user. This option presents an advantage for the users in that the users simply and conveniently operate one software program as opposed to operating two separate programs.

In addition, the collaboration program may be further configured to display a collaboration toolbar integrated with the file-manipulation tool bar; this option presents the advantage of an integrated tool bar for the user (all user controls may be provided by an integrated tool bar).

The collaboration program may be further configured to display the online user collaboration session from within the electronic file as displayed by the file-manipulation program to the user in such a way that options of the online user collaboration session are user visible and user accessible. This option provides the advantage of convenience for the users in terms of ease of usage since the options are visible and accessible.

The collaboration program may be further configured to communicate, via the network connection, the electronic file undergoing amendment to each instance of the data processing system associated with each collaborative member currently involved in the online user collaboration session, via the network connection, in such a way that each instance of the data processing system of each online collaborative member currently involved in the online user collaboration session receives communications from the collaboration program. This option provides the advantage of facilitation of viewing of the electronic file undergoing amendment in which each of the users can view the amendments to the electronic file in real time.

The collaboration program may be further configured to facilitate editing control of the electronic file by only one collaborative member of collaborative members in such a way as to reduce potential confusion of other collaborative members making amendments to the electronic file, while other online collaborative members review the electronic file. This option provides an advantage by reducing the opportunities of misunderstanding between the users while the electronic file is undergoing amendment.

The collaboration program may be further configured to save versions of the electronic file at various points in time in such a way that prior amended versions of the electronic file is reviewable by collaborative members, and the electronic file is retrievable for viewing of various saved versions of the electronic file. This option provides an advantage for each user who desires to review the various versions of the edited document off line, without having to involve the other users during self-review of the various versions of the electronic document.

The collaboration program may be further configured to facilitate sign in of a collaboration member into the online user collaboration session by allowing the collaboration member to sign in and then allow user viewing of contents of the electronic file being displayed by the file-manipulation program, and the online user collaboration session permits collaboration members to collaborate in real-time. This option provides an advantage for ease of usage in real time for the users, since the two programs are integrated as one software package or program.

Some features (options) of the collaboration program are the usage of an existing file-manipulation program (such as an existing word processing program) to: (A) host an on-line collaboration where an electronic file is edited by the collaborating users; (B) host an on-line collaboration to host an on-line collaboration where the electronic file is edited, and can be viewed and, in particular, saved by the various on-line members; (C) host an on-line collaboration where a document is edited, and where it is possible to have audio discussions amongst users, preferably using Microsoft™ CHAT software; (D) host an on-line collaboration where a document is edited, and where it is possible to have an audio discussions amongst users, preferably using the Skype™ software; (E) host an on-line collaboration where a document is edited, and where the buttons for MS™ CHAT software is in the toolbar; and (F) host an on-line collaboration where a document is edited, and where the buttons for Skype™ software is in the toolbar.

Other aspects of the present invention and features of the non-limiting embodiments may now become apparent to those skilled in the art upon review of the following detailed description of the non-limiting embodiments with the accompanying drawings.

The apparatus and the method are configured to obviate or mitigate, at least in part, some of the disadvantages associated with the prior art.

Other advantages, features and characteristics of the present invention, as well as methods of operation and functions of the related elements of the structure, and the combination of parts and the economies of manufacture, may become more apparent upon consideration of the following detailed description and the appended claims with reference to the accompanying drawings, the latter of which is briefly described herein below.

### BRIEF DESCRIPTION OF THE DRAWINGS

The novel features which are believed to be characteristic of the aspects of the present invention, as to its structure, organization, use and method of operation, together with further objectives and advantages thereof, may be better understood from the following drawings in which the examples of the invention may now be illustrated. It is expressly understood, however, that the drawings are for the purpose of illustration and description only, and are not intended as a definition of the limits of the present invention. In the accompanying drawings:

FIG. 1A depicts a schematic representation of an apparatus for user collaboration in accordance with an example of the invention;

FIGS. 1B, and 2 to 12, and 14 to 19 depict a user interface provided by a collaboration program of the apparatus of FIG. 1A; and

FIG. 13 depicts a schematic example of a method, including the operations of the collaboration program of the apparatus of FIG. 1A.

The drawings are not necessarily to scale and may be illustrated by phantom lines, diagrammatic representations and fragmentary views. In certain instances, details not necessary for an understanding of the embodiments (and/or details that render other details difficult to perceive) may have been omitted.

Corresponding reference characters indicate corresponding components throughout the several figures of the Drawings. Elements in the several figures are illustrated for simplicity and clarity and have not necessarily been drawn to scale. For example, the dimensions of some of the elements in the figures may be emphasized relative to other elements for facilitating understanding of the various presently disclosed embodiments. In addition, common, but well-understood, elements that are useful or necessary in commercially feasible embodiments are often not depicted in order to facilitate a less obstructed view of the various embodiments of the present disclosure.

### LISTING OF REFERENCE NUMERALS USED IN THE DRAWINGS

200 collaboration-initiation field
202 alternative collaboration-initiation field
206 sign-out field
208 change-group field
210 group information field
212 group-members field
214 create-group field
216 load file field
218 user-name field
220 user password field
222 sign-in field
224 on-line toolbar field
226 create-group field
228 group name field
230 add-members field
236 finished field
238 group-members field
240 username list field
242 change display name field
244 display name color field
246 collaboration display field
248 collaboration selection field
250 online-members field
252 offline-members field
254 sign-out field
256 user-listing field
258 warning field
260 online-collaboration field
262 file-content field
264 online-collaboration field
266 discussion field
268 field
270 control-switch field
272 database field
274 request field
276 contact-information field
278 control option field
280 collaboration invitation field
282 change group window
284 unhide button
286 pass control button
287 pass-control window
290 pass-control button
292 sign-out window
294 sign-in window
302 to 378 operation
900 apparatus
901 data processing system
902 input device
904 output device
906 network connection
908 processor assembly
910 memory assembly, or non-transitory machine-readable storage medium
911 processor-executable instructions
912 collaboration program
913 memory assembly, or non-transitory machine-readable storage medium
914 electronic file
916 online user collaboration session
918 file-manipulation program
920 user interface
922 collaboration tool bar
924 file-version database

### DETAILED DESCRIPTION OF INVENTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of the description herein, the terms “upper,” “lower,” “left,” “rear,” “right,” “front,” “vertical,” “horizontal,” and derivatives thereof shall relate to the examples as oriented in the drawings. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments (examples), aspects and/or concepts defined in the appended claims. Hence, specific dimensions and other physical characteristics relating to the embodiments disclosed herein are not to be considered as limiting, unless the claims expressly state otherwise. It is understood that “at least one” is equivalent to “a”.

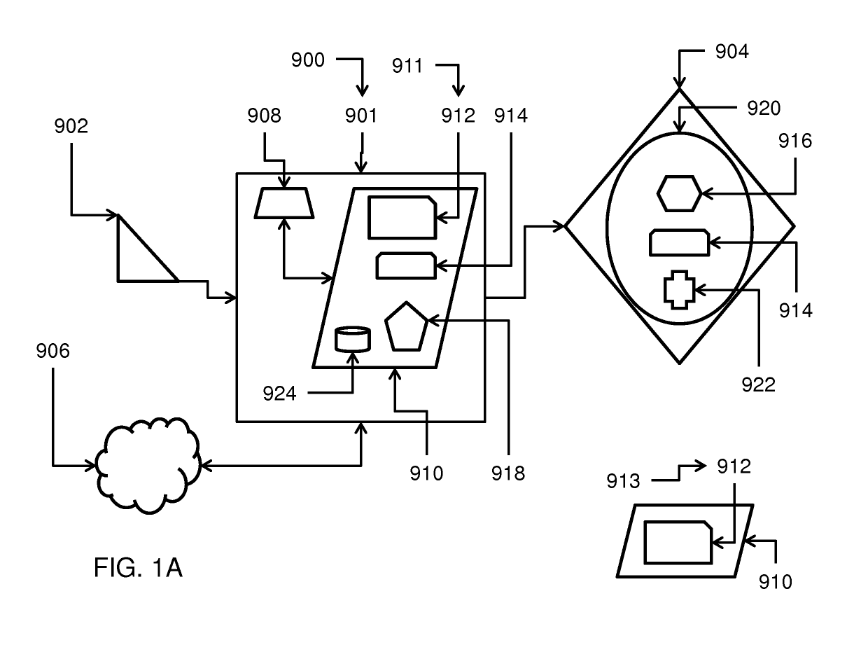

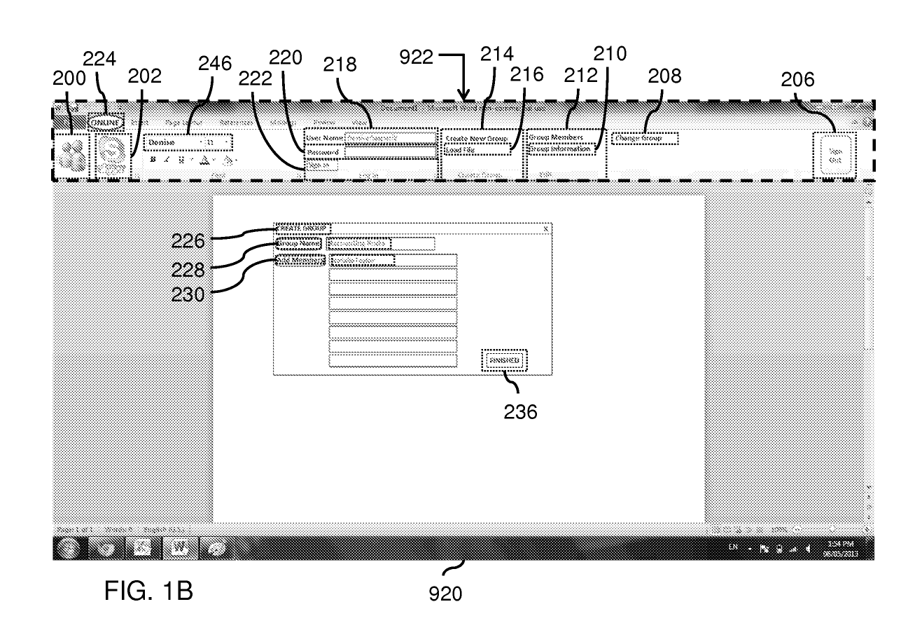

FIG. 1A depicts a schematic representation of an apparatus 900 for user collaboration. The apparatus 900 includes a data processing system 901. The data processing system 901 may be called a server system. The data processing system 901 is configured to interface with an input device 902. The input device 902 (such as a keyboard) is configured to receive user commands from a user. The data processing system 901 is also configured to interface with an output device 904. The output device 904 (such as a display unit) is configured to output or to display information to the user. The data processing system 901 is configured to interface with a network connection 906. The network connection 906 may include an Internet connection or any type of network connection. The data processing system 901 includes a processor assembly 908, and a non-transitory machine-readable storage medium 910, hereafter referred to as the memory assembly 910. The memory assembly 910 is operatively coupled to the processor assembly 908. The memory assembly 910 is configured to tangibly embody (store) a set of processor-executable instructions 911. The set of processor-executable instructions 911 includes a collaboration program 912. The memory assembly 910 is configured to tangibly embody (store) an electronic file 914 (such as a word processing document). The collaboration program 912 is configured to execute the operations that are described in association with the figures.

In accordance with an option, the apparatus 900 includes the data processing system 901 having the collaboration program 912. In accordance with another option, the apparatus 900 includes the collaboration program 912 tangibly installed (stored) on a non-transitory machine-readable storage medium 913, hereafter referred to as the memory assembly 913 (such as, a disk, etc.). The memory assembly 913 is configured to be used in the process of installation of the collaboration program 912 onto the memory assembly 910 of the data processing system 901. The non-transitory machine-readable storage medium 913 tangibly embodies the collaboration program 912.

The collaboration program 912 is configured to display (provide) a user interface 920 via the output device 904. The user interface 920 is also called a graphical user interface. A schematic example of a user interface 920 is depicted in FIG. 1B.

Referring to FIG. 1A, the user interface 920 is configured to display, at least in part, the output of a file-manipulation program 918 (either with or without the cooperation of the collaboration program 912) via the output device 904. The file-manipulation program 918 is configured to manipulate an electronic file 914. According to an option, the collaboration program 912 is integrated with the file-manipulation program 918 (if so desired). According to another option, the collaboration program 912 operates independently of the file-manipulation program 918 (if so desired). Examples of the file-manipulation program 918 include a word-processing program, and/or a spreadsheet program, etc. Examples of the electronic file 914 include a text file, a number file, and/or a static image file (such as an electronic photographic file, and/or an electronic image configured to provide a video image, etc.)

The collaboration program 912 is configured to manipulate the user interface 920 in such a way that the user interface 920 displays a collaboration-initiation field 200 to the user via the output device 904. It may be appreciated that hereafter, for the ease of describing the user interface 920, the user interface 920 is described as being configured to display a collaboration field (a collaborative field or field, etc.), and it may be understood that what is meant by this description is that the collaboration program 912 is configured to manipulate the user interface 920 in such a way that the user interface 920 displays the collaboration field (or the collaboration element) to the user via the output device 904.

The collaboration program 912 is configured to display a user interface 920. The collaboration program 912 is configured to display, via the user interface 920: (A) contents of an electronic file 914 being controlled for amendment by a selected collaboration member of a collaboration group, and also being disabled for amendment by the remaining collaboration members; and (B) contents of an exchange of user comments associated with an online user collaboration session 916 in which the comments are received from the collaboration members participating in the online user collaboration session 916, and the user comments facilitate collaborative amendment of the contents of the electronic file 914.

The collaboration program 912 is configured to provide or to display (via the output device 904) in a user interface 920: (A) contents of an electronic file 914 undergoing user amendment; (B) an online user collaboration session 916 involving collaboration members of a user-collaboration group; and (C) a collaboration tool bar 922. The online user collaboration session 916 may include facilitation of a virtual meeting conducted in a communication mode (such as a video communication and/or a text communication, and/or an audio discussion, etc.).

The collaboration program 912 is configured to display a collaboration tool bar 922, and to display an amendment tool bar of a file-manipulation program 918 configured to amend contents of the electronic file 914.

It is understood that the output device 904 is configured to display the contents of the electronic file 914, and that the memory assembly 910 is configured to store (save) a working version of the electronic file 914.

The collaboration program 912 is configured to provide or to display (via the output device 904) in the user interface 920, the online user collaboration session 916 involving online collaboration members of the user-collaboration group.

The collaboration program 912 is further configured to assist user setup of the user-collaboration group having the identification of collaboration members.

The collaboration program 912 is further configured to facilitate sending invitations to the collaboration members identified by the user-collaboration group in such a way that the online user collaboration session 916 involves at least some of the collaboration members.

The collaboration program 912 is further configured to selectively identify a collaboration member from the user-collaboration group to be an editing controller (a selected one or instance of the collaborator members) in charge of making electronic amendments to the electronic file 914 while the online user collaboration session 916 is active.

The collaboration program 912 is further configured to permit only the collaboration member being selected as an editing controller to make electronic amendments to the electronic file 914.

The collaboration program 912 is further configured to pass the role of the editing controller from the collaboration member currently acting as the editing controller to another collaboration member from the user-collaboration group to be the editing controller in command (in charge) of making electronic amendments to the electronic file 914 while the online user collaboration session 916 is active.

The collaboration program 912 is further configured to pass the role as the editing controller to only one collaboration member at a time.

The collaboration program 912 is further configured to permit one, and only one, of the collaboration members to act as the editing controller.

The collaboration program 912 is further configured to facilitate the online user collaboration session 916 by using real-time collaboration communication between the collaboration members. The real-time collaboration communication may include audio-based collaboration information, video-based collaboration information, and/or text-based collaboration information.

The collaboration program 912 is further configured to be integrated with a file-manipulation program 918. The file-manipulation program 918 is configured to facilitate user amendment of the electronic file 914 in response to user commands received via the input device 902 of the data processing system 901. It may be appreciated that user amendment may include editing or manipulation of the electronic file 914.

The collaboration program 912 may be further configured to not be integrated with the file-manipulation program 918. The file-manipulation program 918 is configured to facilitate user amendment (editing or manipulation) of the electronic file 914 in response to user commands received via the input device 902 of the data processing system 901.

The collaboration program 912 is further configured to display the online user collaboration session 916 from within the electronic file 914 as displayed by the file-manipulation program 918 to the user.

The collaboration program 912 is further configured to display the online user collaboration session 916 from within the electronic file 914 as displayed by the file-manipulation program 918 (to the user) in such a way that options of the online user collaboration session 916 are user visible and user accessible.

The collaboration program 912 is further configured to communicate, via the network connection 906, the electronic file 914 undergoing amendment to each data processing system (not depicted) associated with each collaborative member currently involved in the online user collaboration session 916 (via the network connection 906). This is done in such a way that each instance of the data processing system (computer) of each online collaborative member currently involved in the online user collaboration session 916 may receive communications from the collaboration program 912.

The collaboration program 912 is further configured to facilitate editing control of the electronic file 914 by only one of the collaborative members (present in the online collaboration session) in such a way as to reduce potential confusion of other collaborative members making amendments (edits) to the electronic file 914, while other online collaborative members simultaneously review the electronic file 914.

The collaboration program 912 is further configured to save (store, write) versions of the electronic file 914 at various points in time in such a way that prior amended versions of the electronic file 914 may be reviewed by the collaborative members. This is done in such a way that the electronic file 914 may be retrieved for viewing of various saved versions or instances of the electronic file 914. The versions of the electronic file 914 are saved (stored) in a file-version database 924 that is tangibly stored in (on or within) the memory assembly 910.

The collaboration program 912 is further configured to facilitate sign in of a collaboration member into an online user collaboration session 916 by allowing the collaboration member to sign in and then allow user viewing of the contents of the electronic file 914 being displayed by the file-manipulation program 918, and the online user collaboration session 916 permits the collaboration members (users) to collaborate in real-time (by audio conferencing, video conferencing or by a text-based conferencing or meeting). The file-manipulation program 918 may include, by way of example, a word-processing program, a spreadsheet program, etc. It may be appreciated that other examples of the file-manipulation program 918 are possible.

The collaboration program 912 is further configured to integrate a virtual collaboration meeting in which features of the file-manipulation program 918 are user visible and user assessable.

The collaboration program 912 is further configured to display (show) the electronic file 914 from within the file-manipulation program 918 and the collaboration tool bar 922, in which the collaboration tool bar 922 is configured to facilitate initiation of a collaboration session amongst the collaboration members of the collaboration group.

The collaboration program 912 is further configured to save historical versions of the electronic file 914 to the file-version database 924. Options for saving the versions of the electronic file 914 may be: (A) at predetermined time intervals (such as every five minutes), and/or (B) whenever a file-save request is received by the collaboration program 912 from a collaboration member.

FIGS. 1B, and 2 to 12 depict a user interface 920 provided by a collaboration program 912 of the apparatus 900 of FIG. 1A.

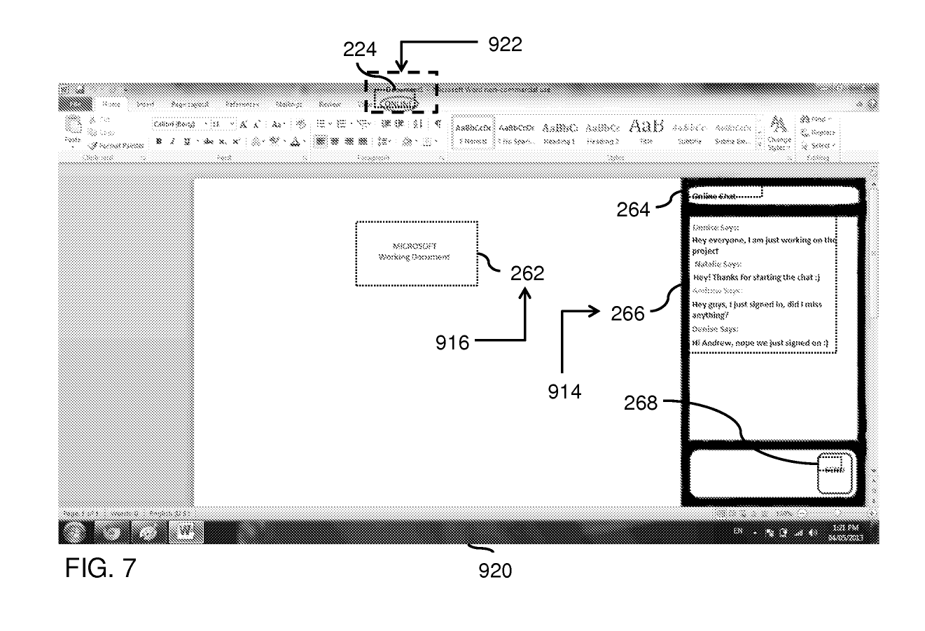

Referring now to FIG. 1B, the collaboration-initiation field 200 is configured to initiate a user-collaboration session. The user-collaboration session involves the collaboration efforts of two or more users who are physically (remotely) located away from each other. Each of the users has access to their own instance of the user interface 920 provided by their own instance of the output device 904 of their own instance of a data processing system 901. The user-collaboration session may be conducted via an instant messaging method (text messaging and/or video messaging), such as INSTANT MESSAGING™ software, available from Microsoft Corporation of Redman, Wash., USA. The collaboration-initiation field 200 is configured to display an online-collaboration field 264 (such as a text box) to the user in response to the user selecting (clicking) the collaboration-initiation field 200. The online-collaboration field 264 may be displayed to the user on the right side of the user interface 920 showing the electronic file 914 undergoing user manipulation. The online-collaboration field 264 (such as, a text-chat window) is depicted in FIG. 7. The online-collaboration field 264 is configured to facilitate a virtual meeting between the users. The online-collaboration field 264 is configured to facilitate a virtual meeting between users in such a way that the users may collaborate during the virtual setting, rather than meeting and collaborating in person.

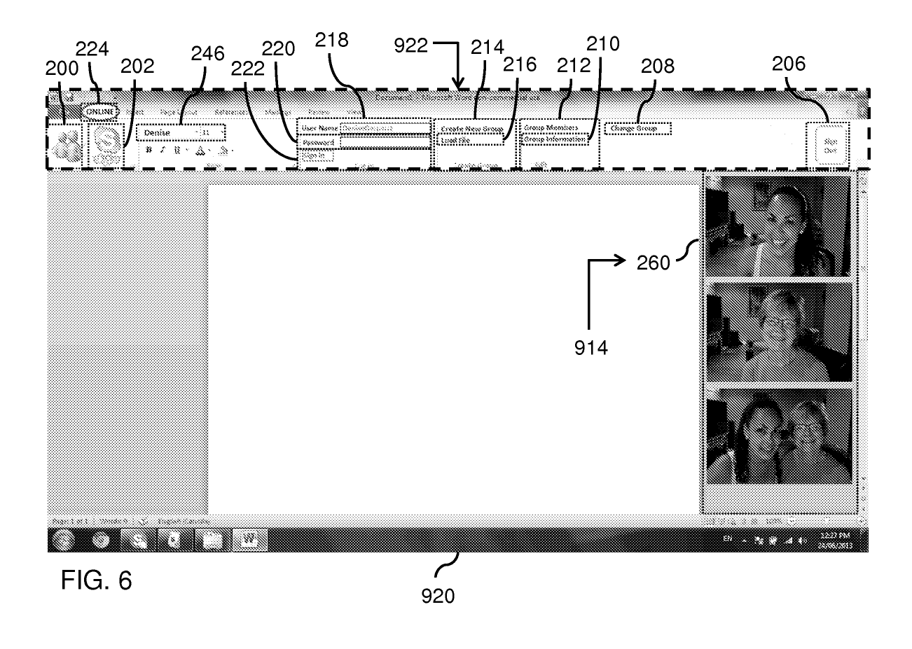

The user interface 920 may be configured to display an alternative collaboration-initiation field 202. The alternative collaboration-initiation field 202 is configured to initiate a user-collaboration session via a type of collaboration connection, such as a SKYPE™ collaboration connection, available from Microsoft Corporation. The alternative collaboration-initiation field 202 is configured to display an online-collaboration field 260 (text and/or video) to the user in response to the user selecting (clicking) the alternative collaboration-initiation field 202. The online-collaboration field 260 is depicted in FIG. 6. The online-collaboration field 260 may be displayed on the right-hand side of the user interface 920 showing the electronic file 914 undergoing user manipulation. The online-collaboration field 260 may include an online video chat window. The alternative collaboration-initiation field 202 is configured to facilitate a virtual meeting between users in such a way that the users may collaborate during the virtual setting, rather than meeting and collaborating in person.

The user interface 920 may be configured to display a sign-out field 206. The sign-out field 206 is configured to allow a user of the virtual collaboration session (meeting) to sign out of the collaboration session.

The user interface 920 may be configured to display a change-group field 208. The change-group field 208 is configured to facilitate user selection of a collaboration group, so that the user that wishes or desires to change collaborating with a different collaboration group (if the user is a member of other collaboration groups involved with unrelated collaboration projects). Once a user (collaborator) has signed in online, via a sign-in field 222, the change-group field 208 is configured to indicate a user-availability status, such as an unavailable status (greyed-out) in which the user is not available, or an available status (not greyed-out) in which the user is available for collaboration in the event there is an interest by other users acting as members of a collaboration group.

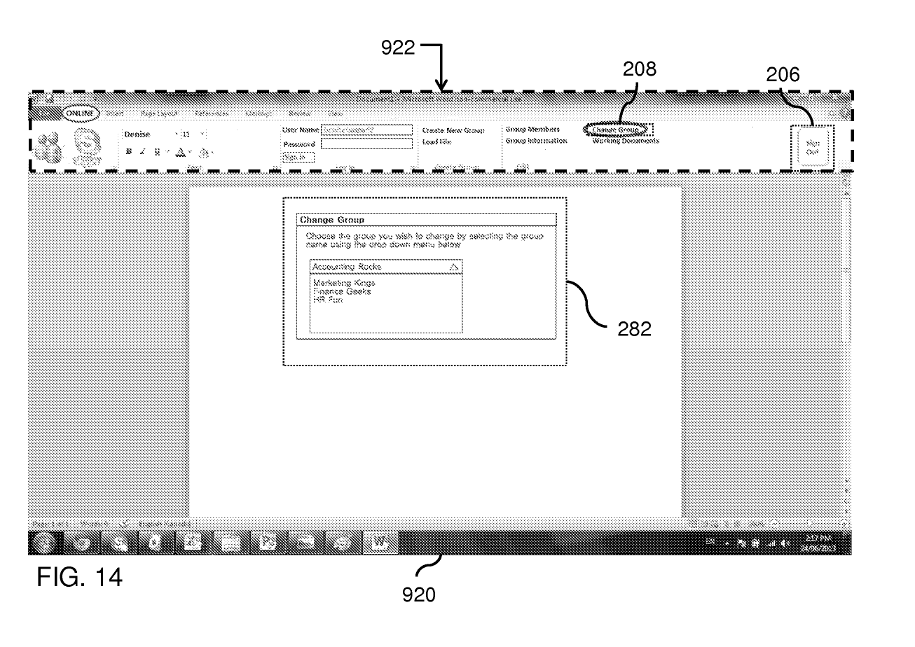

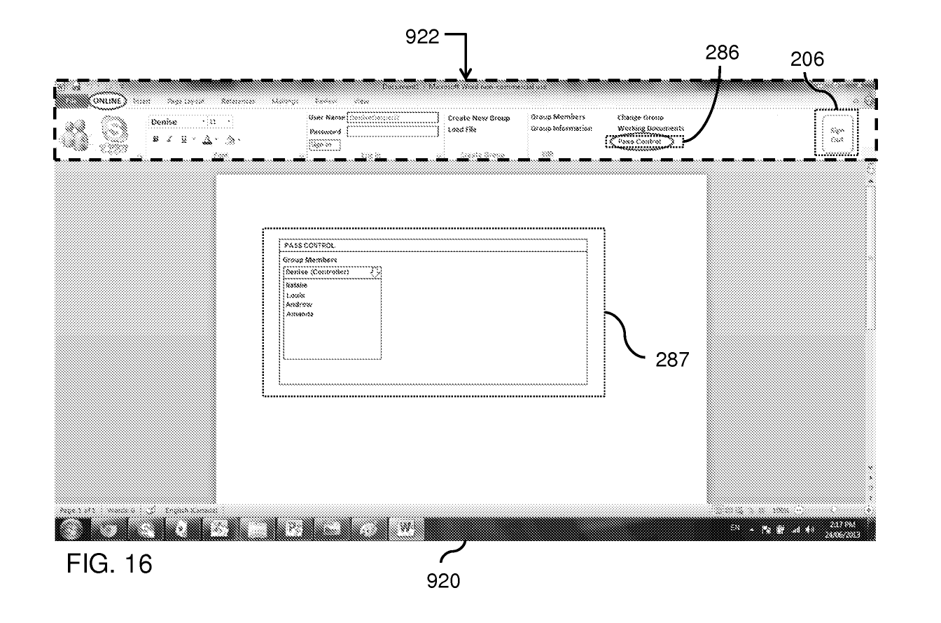

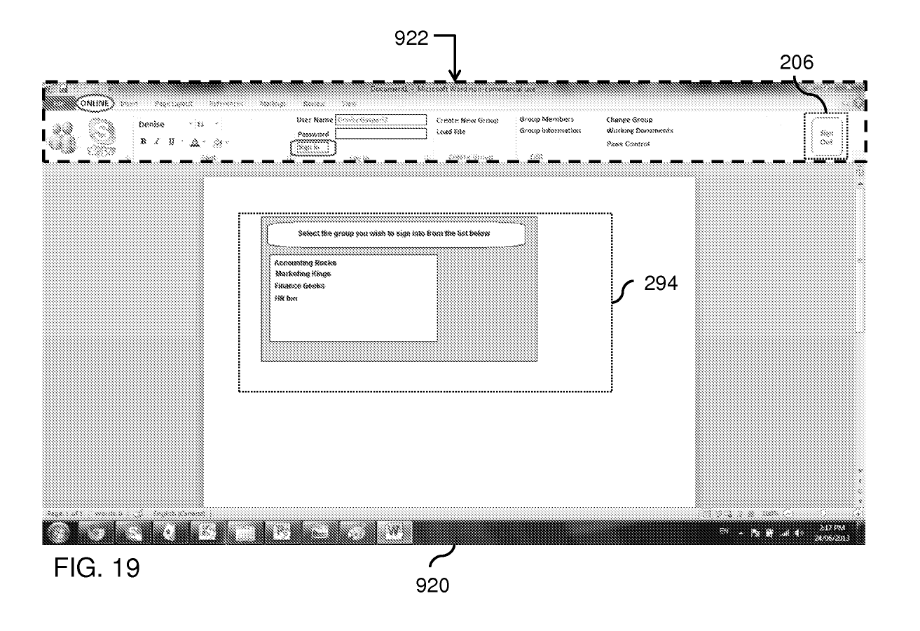

A change-group field 208 allows users of the program to switch to collaborate with a different group, if they are working on multiple projects and belong to one or more groups. Once a user has signed in online (refer to FIG. 1, Item 222) the change-group field 208 may go from being unavailable (greyed-out) and may become available to use. Once the change-group field 208 is clicked on, a pop-up window (refer to FIG. 14, the change group window 282) may appear listing the group(s) the user belongs to. There they can also delete groups from their list in which they are no longer active, if they wish to do so. The list of groups to which a particular user belongs is saved individually to their username/password, so that when they sign into the online collaboration using a different program (Eg. Microsoft Excel and the like instead of a word processing program), they are able to access all of their groups with ease (refer to FIG. 19, Item 294). Referring to FIG. 16, in response to the user selecting (clicking) the change-group field 208, a change group window 282 is shown (displayed) to the user (collaborator). The change group window 282 may include a pop-up field or a pop-up window, etc. The change group window 282 is configured to provide a listing of the collaboration groups that the user is a member thereof. From the change group window 282, the user may delete collaboration groups from the change group window 282 in which the user is no longer active therewith (if so desired). The list of collaboration groups to which a particular user belongs thereto is saved (for the user) along with the user's username and user password information; in this way, when the user signs into the collaboration program 912 using a different type of file-manipulation program 918 (example, from a word-processing program to an electronic spreadsheet program), the user may access their collaboration groups (if so desired).

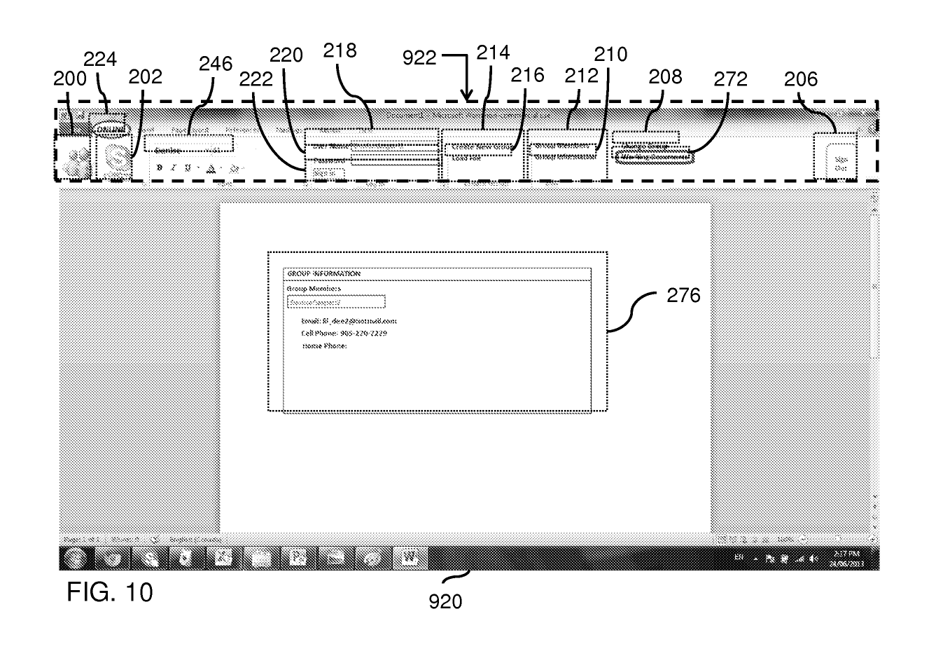

The user interface 920 may also be configured to display a group information field 210. The group information field 210, once selected (clicked) by the user, is configured to initiate the display of a contact-information field 276 as depicted in FIG. 10. The contact-information field 276 is configured to display user-contact information, such as e-mail addresses and phone numbers for each user that are members of a particular collaboration group. As an option, the user members of the collaboration group may grant access to their contact information, in which case then the other members of the collaboration group are able to view the user contact information, whether or not the user is on-line or is off-line.

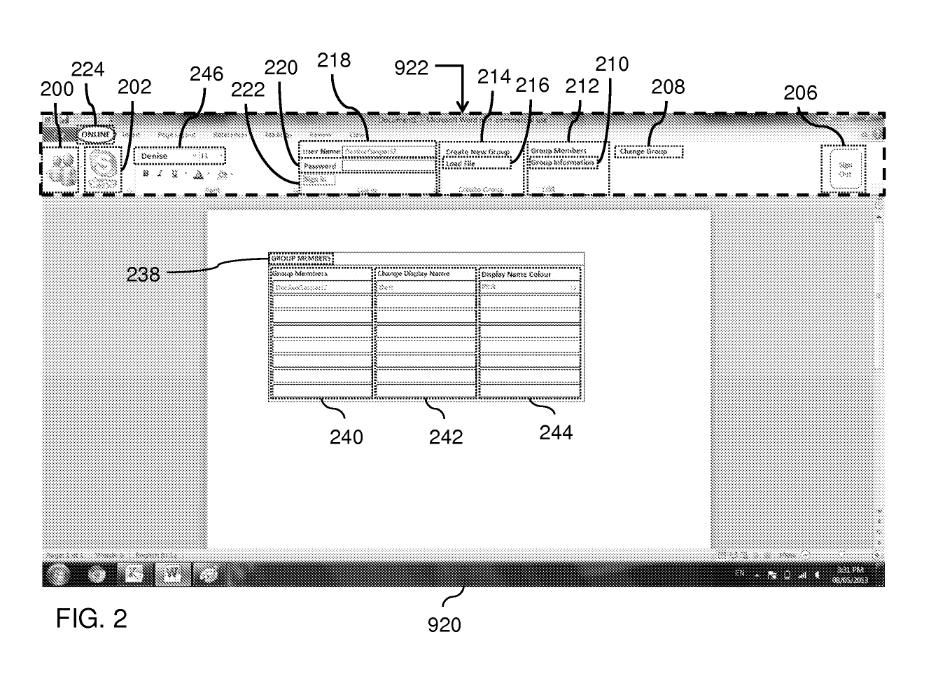

The user interface 920 may also be configured to display a group-members field 212. The group-members field 212, once selected (clicked) by the user, is configured to display a group-members field 238 (depicted in FIG. 2). The group-members field 212 is configured to allow individual users to access the group-members field 238. The group-members field 238 is configured to allow the user to change the contact display information for each of the other users within a particular collaboration group.

The user interface 920 may also be configured to display a create-group field 214. The create-group field 214 is configured to assist the user in the setup (creation of) a new collaboration group of online collaborators in response to the user selecting (clicking) the create-group field 214. Once the create-group field 214 is selected, the user is deemed the creator of a collaboration group, and the user may add collaboration members to the collaboration group via a create-group field 226, which is depicted, for example, as a pop-up window in FIG. 1B.

The user interface 920 may also be configured to display a load file field 216. The load file field 216 is used to upload an electronic file 914 from the user's personal electronic files located on the data processing system 901 operated by the user. It may be appreciated that the collaboration member may upload a file to be worked on in a collaborative fashion. Regarding formats of older versions of an electronic file 914 to be manipulated during collaboration, it may be appreciated that software, such as Microsoft Word™ software, Microsoft Excel™ software, Microsoft PowerPoint™ software, etc., has compatibility features to aid in the issue where the electronic file 914 is configured to be formatted in older format than the most current format version being used by the file-manipulation program 918 (software program) being utilized.

The user interface 920 may also be configured to display a user-name field 218 and a user password field 220, which are used to facilitate sign in of the user into the collaboration program 912. The user-name field 218 and the user password field 220 are configured to receive a user name and a user password (respectively) from the user via a keyboard as the input device 902 of FIG. 1A. For example, the username and the password of the user may be the user name associated with a Skype™ account, if so desired.

The user interface 920 may also be configured to display a sign-in field 222. The sign-in field 222 is configured to sign in the user to the data processing system 901, and thereby gain access to the collaboration-initiation field 200 and/or the alternative collaboration-initiation field 202. In response to the user selecting (clicking) the sign-in field 222, the collaboration-initiation field 200 and the alternative collaboration-initiation field 202 change status from being unavailable status (greyed-out) to available status (not greyed-out or colorized); once available, the user may select either of the collaboration-initiation field 200 and/or the alternative collaboration-initiation field 202.

The user interface 920 may also be configured to display an on-line toolbar field 224. The on-line toolbar field 224 is displayed to the user, and is configured to provide the toolbar where a user has access to online collaboration features and methods. The on-line toolbar field 224 may be used in software programs such as Microsoft Word™ software, Microsoft Excel™ software, Microsoft PowerPoint™ software and the like, wherever online collaboration is desired by a user.

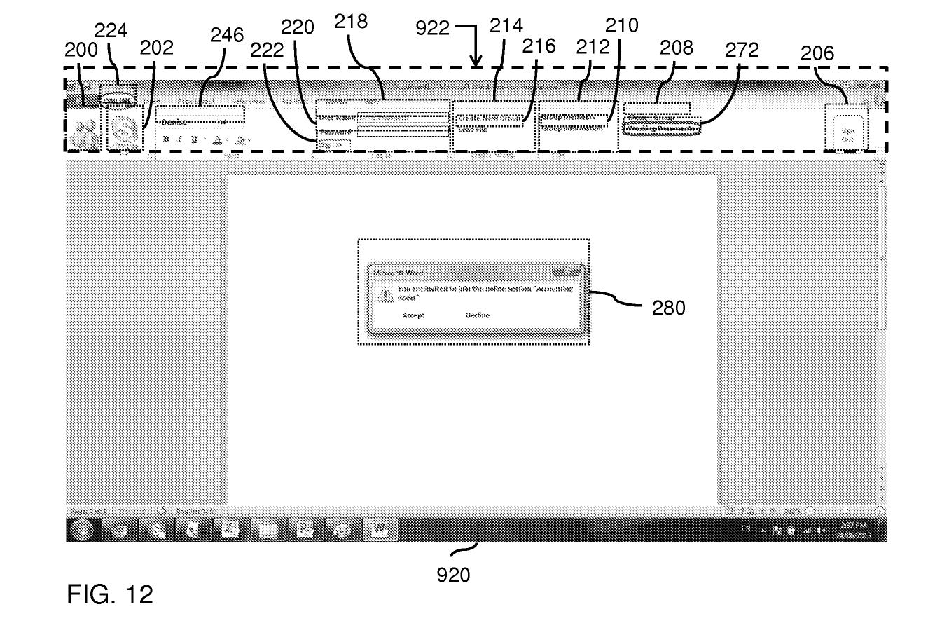

The user interface 920 may also be configured to display a create-group field 226, and an add-members field 230. The create-group field 226 is configured to facilitate setting up of a new collaboration group. The create-group field 226 and the add-members field 230 are displayed (via a pop-up window), in response to the user selecting (clicking) the create-group field 214. The create-group field 226 is configured to allow the user who creates the collaboration group to make a group name for the collaboration group in a group name field 228 as depicted in FIG. 1B. The user may enter, into the group name field 228, a group name for a particular collaboration project. The add-members field 230 is configured to permit the user to add collaboration members to the collaborator group, via, for example, their SKYPE™ usernames. Once added, each collaboration user accepts an invitation to join the collaboration group; otherwise, the invited user may not be included via a collaboration invitation field 280 as depicted in FIG. 12. The add-members field 230 is configured to display the identification credentials of the user who created the collaboration group. The add-members field 230 is also configured to allow the user to input (enter) the usernames of each collaboration group member, in text boxes located to the right side. There is no limit to the number of members who may be added to each collaboration group; however, the number of collaboration group members may affect the performance of the online collaboration, for example, since there may only be up to four chat windows open for the SKYPE™ software option at any one time. The usernames to be entered into the add-members field 230 would have been created when the users previously created their respective SKYPE™ software accounts.

The user interface 920 may also be configured to display a finished field 236 (see FIG. 1B). The finished field 236 is configured to finish the process of setting up an online collaboration group in response to the user selecting (clicking) the finished field 236. Once the finished field 236 is selected by the user, the collaboration program 912 (of FIG. 1A) is configured to send an invitation to the collaboration members whose usernames have been entered into the create-group field 226. Each collaboration user either accepts or declines the invitation to join the collaboration group. Collaboration group members do not have access to online collaboration sessions of the collaboration group unless the collaboration member accepts their invitation to join the collaboration group.

Reference is now made to FIG. 2. The user interface 920 may also be configured to display a group-members field 238, which may be a pop-up window. The group-members field 238 is configured to allow the user to change the manner in which the user names of the members of the collaboration group are to be displayed during a collaboration session, such as in the MSN Messenger™ chat window (and the like). This arrangement helps to clarify identities of the collaboration member (users) to be displayed to the user. For example, if a user finds it too difficult to determine the name of the collaborator based on the username of the collaborator, the user may change a name of the collaborator to something more familiar to the user. The changed name may only appear to that the user viewing the user interface 920, and is not displayed to the remaining collaborators of the collaboration group. Each member has the same ability to change the names of the other collaboration members to something that they find more familiar and comfortable. For instance, in an educational environment if there are two users who have the same name (such as, Andrew) in the collaboration group, then to avoid any confusion, the user may label one collaboration member ‘short Andrew’ and the other collaboration member as ‘tall Andy’ for the benefit of the user in order to distinguish between the two collaboration members.

The group-members field 238 may also be configured to display a username list field 240. The username list field 240 is configured to display a list of the usernames (originally created through SKYPE™ software by respective collaboration members) of the members of the collaboration group. The group-members field 238 is configured to display a change display name field 242. The change display name field 242 is configured to display fields in which the user may change the user names of the collaboration members to a different display name. Each member of the collaboration group may change the names of the usernames, in accordance with their preferences.

The change display name field 242 may also be configured to allow the user to type in the display name, on a separate line item for each member of the collaboration group, to whatever the user desires to view for when the collaboration member is on-line during a collaboration session (such as, during an MSN Messenger™ chat session). Each changed display name corresponds with a respective collaboration user in the username list field 240 located to the left side.

The group-members field 238 may also be configured to display a display name color field 244. The display name color field 244 may be a drop-down colour block menu or may be a colour wheel instead of text boxes (if so desired). The display name color field 244 is configured to allow the user to choose (select) a display font color for a particular member of the collaboration group (whose username is shown in the username list field 240) that the user is changing to a different display name (to be displayed in the change display name field 242). For collaborative group chat sessions (MSN Messenger™ software, and the like), the changed display name of the collaboration member may appear in the corresponding color as chosen. Each color in the display name color field 244 corresponds with the name indicated in a change display name field 242, and the username list field 240. As an option, the display name color field 244 may appear as a drop-down color block menu or as a color wheel, if so desired.

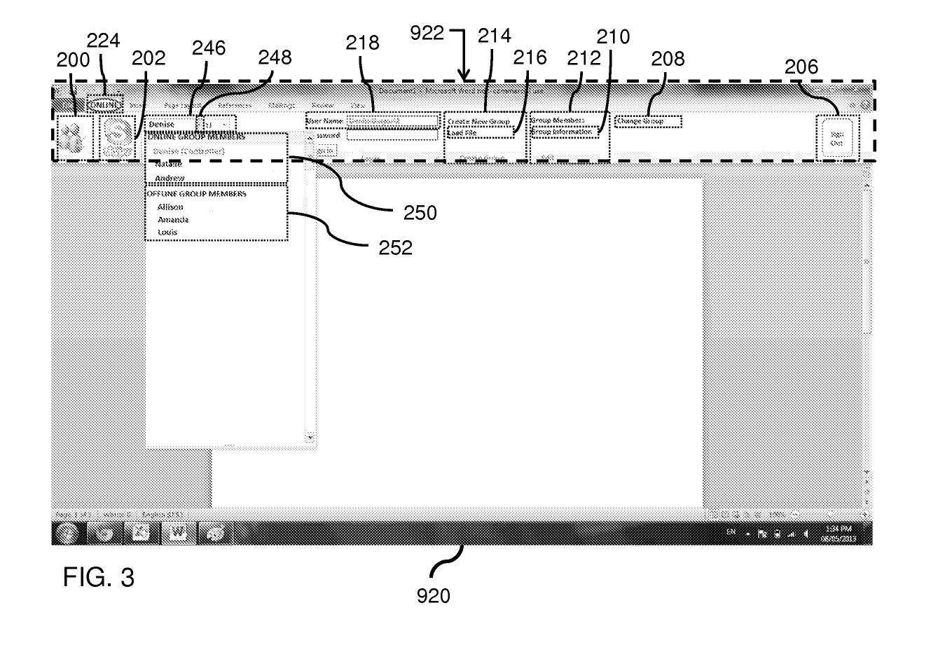

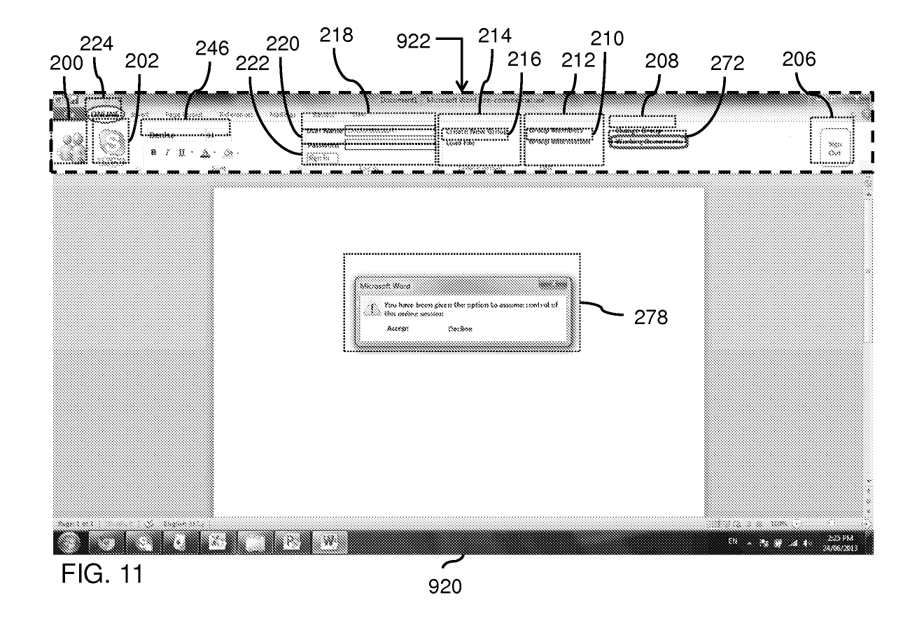

Reference is now made to FIG. 3. Once the user has accepted the invitation to join the group, the user is be able to see which group members are online and which are offline via the drop-down arrow in the online tab. The user is able to see which user is the current controller (control editor) of the collaboration document. The user is able to see their username in the collaboration display field 246 displayed under the on-line toolbar field 224, and may click the collaboration selection field 248 to see the status of other group members who are currently listed as online (via a list of online-members field 250) or listed as offline (via a list of offline-members field 252), regardless of whether these users are the current controller (document editor) or not. A collaboration selection field 248 is used to allow the users to see the drop-down menu of which group members are online (refer to FIG. 3, the list of online-members field 250) or offline (refer to FIG. 3, the list of offline-members field 252). The online-members field 250 of the collaboration selection field 248 showes which users are currently online (shown by their display names, if changed from their original usernames). The username appears greyed-out in this column. It is also shown, beside the name, which user is the current controller of the collaboration group. If a member's username was not changed to a more convenient display name, their original username is shown here by default. Each member of the group who is active in a session is able to access this list, whether they are the controller of the session or not. The user also sees the member who is in control via the controller title next to their display/username. The collaboration display field 246 is configured to show the username, originally created through the SKYPE™ account. The collaboration selection field 248 to the right shows a menu of the online and offline group members (refer to FIG. 3, the list of online-members field 250 and the list of offline-members field 252), which every group member is able to see, whoever is the current controller (editing controller) of the document. The offline-members field 252 of the collaboration selection field 248 showes which users are currently offline (shown by their display names, if changed from their original usernames (username list field 240 and change display name field 242). If a member's username was not changed to a more convenient display name, their original username is shown here by default. None of these users may be able to assume control since they are not online, and therefore their names may not appear in the drop-down list of the pass control button 286 (refer to FIG. 16). The user interface 920 may also be configured to display a collaboration display field 246 and a collaboration selection field 248. The collaboration display field 246 is configured to display the user name of the user, such as the user name associated with the Skype™ account of the user. A collaboration selection field 248 is configured to display a menu field showing a list of online-members field 250, and a list of offline-members field 252 in response to the user selecting (clicking) the collaboration selection field 248. The collaboration selection field 248 may include a drop-down arrow field. For the case where the user is the user having exclusive editing control of the electronic file 914 (such as a word processing document), then the collaboration selection field 248 is configured to pass off control from the user to another online collaboration member in which they may then have exclusive editing control of the electronic file 914. Once the user selects or chooses the collaboration user to take over editing control, a control option field 278 (depicted in FIG. 11) is displayed to the user being proposed for editing control, and the control option field 278 requests the proposed user to either accept or decline editing control of the electronic file 914.

The user interface 920 may also be configured to display an online-members field 250. The online-members field 250 may include a drop-down menu, and is configured to display a listing of users who are currently online (shown by their display names, if changed from their original usernames). The user name of the user may appear as greyed-out if so desired. The online-members field 250 is configured to display (indicate) which user is the current editing controller of the collaboration group. If the user has not changed a member's username to a more convenient display name, the original username is shown in the online-members field 250 or the offline-members field 252 (by default). For the case where the user viewing the user interface 920 is the current editing controller, the user may choose one of the user names in the online-members field 250 to pass control off thereto.

A control option field 278 may also be displayed to the user that is proposed to take editing control, in which case the proposed user may either accept or decline editing control of the electronic file 914. Once the new user (collaboration member) has accepted, the user previously in editing control is no longer able to make changes or amendments to the electronic file 914 (until such time editing control is passed back to the previous user).

The user interface 920 may also be configured to display the offline-members field 252. The offline-members field 252 may include a drop-down menu. The offline-members field 252 is configured to activate in response to the user selecting the collaboration selection field 248. The offline-members field 252 is configured to display the names of the collaborators who are currently offline (shown by their display names, if changed from their original usernames). For the case where the user has not changed a username of the collaborator member of the collaboration group to a more convenient display name, the original username is shown by the offline-members field 252 by default. None of these users listed in the offline-members field 252 may assume control since they are not online. The creator of the group is not always the editor. Whoever signs into the group first at any given time may be the first controller and can pass control to whomever they wish during the online session. Once the current controller of a group wishes to sign out, a pop-up window prompts and asks that group member to pass control over to a member who is still online. This way the rest of the group can continue in an online meeting. Members are also able to access the working documents saved within a particular group without having to be in an online session. They may be able to open the document within the group and work and save the document for the rest of the group to access. This way if more than one member is online working individually, it may not create a confusion of having to pass control back and forth. This is done by working offline but still being able to save the user's work to the working documents within the group.

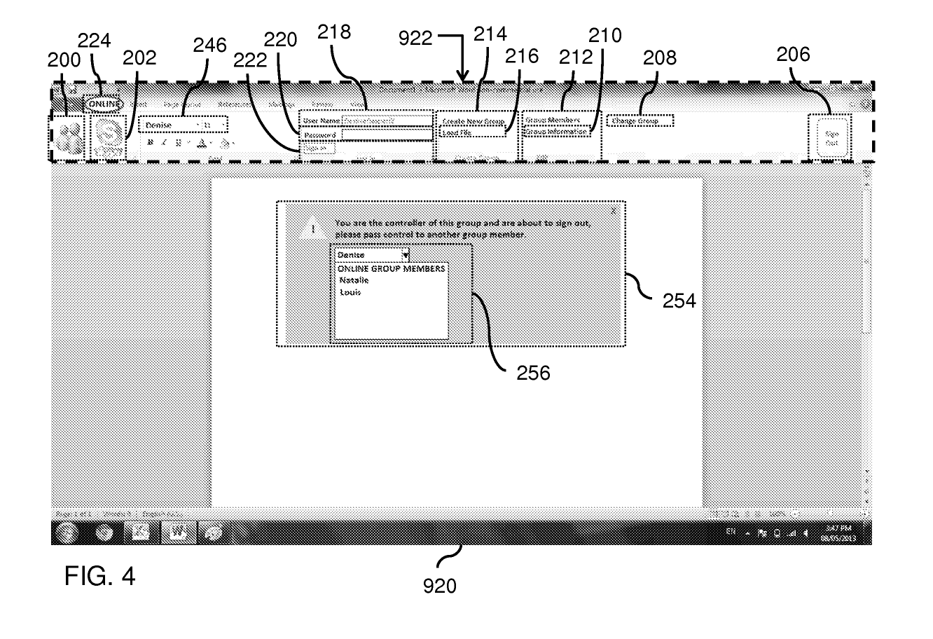

Referring now to FIG. 4, the user interface 920 may also be configured to display a sign-out field 254. The sign-out field 254 may include a pop-up window. The sign-out field 254 is configured to be activated for the case where the current editing controller of the collaboration group attempts to sign out while a collaboration group meeting is still in session. The sign-out field 254 is configured to allow the current editing controller to pass control off to another online member of the collaborating group before the current editing controller may leave, so that another user may assume the lead of current editing controller and further collaboration of the electronic file 914 may then proceed.

The user interface 920 or the sign-out field 254 may also be configured to display a user-listing field 256. The user-listing field 256 may include a drop-down menu. The user-listing field 256 is configured to allow the current editing controller (who is signing out of the collaboration-group meeting) to pass editing control to any of the other collaborator members who are currently online (before signing out). The user name of the editing controller appears in the top of the user-listing field 256 (if so desired).

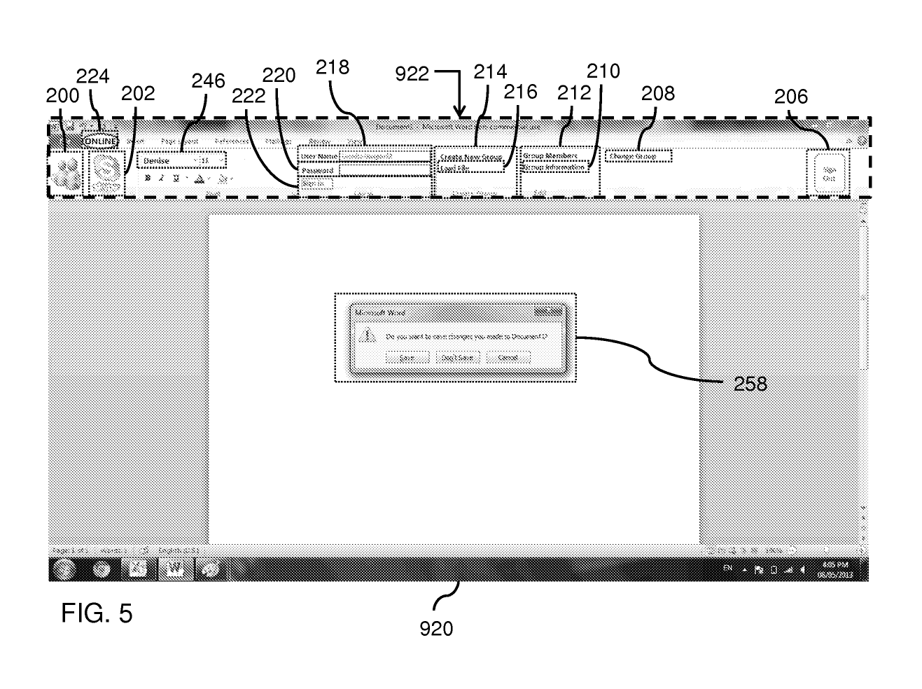

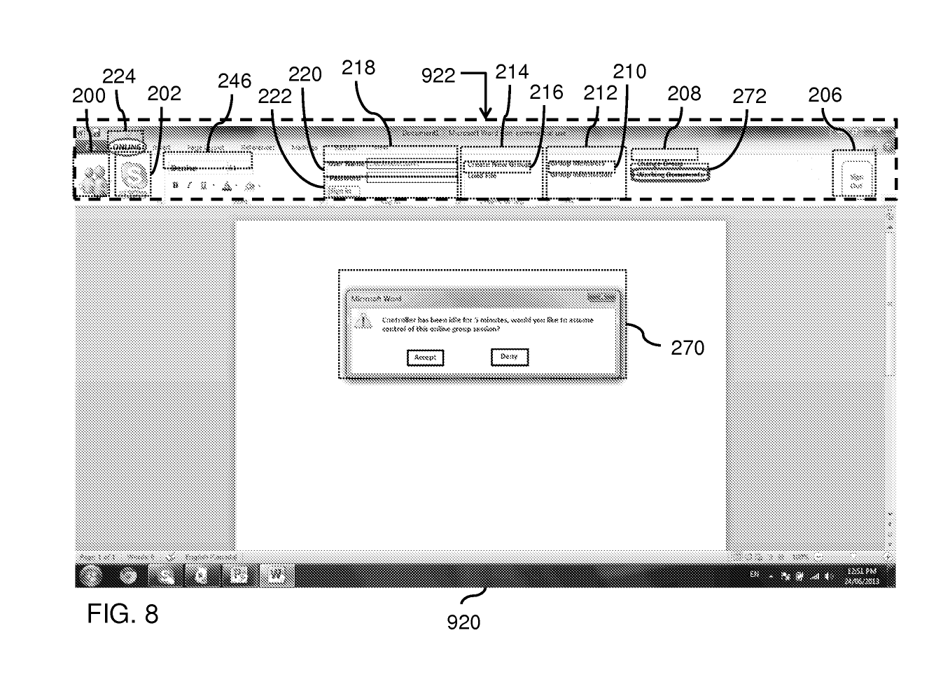

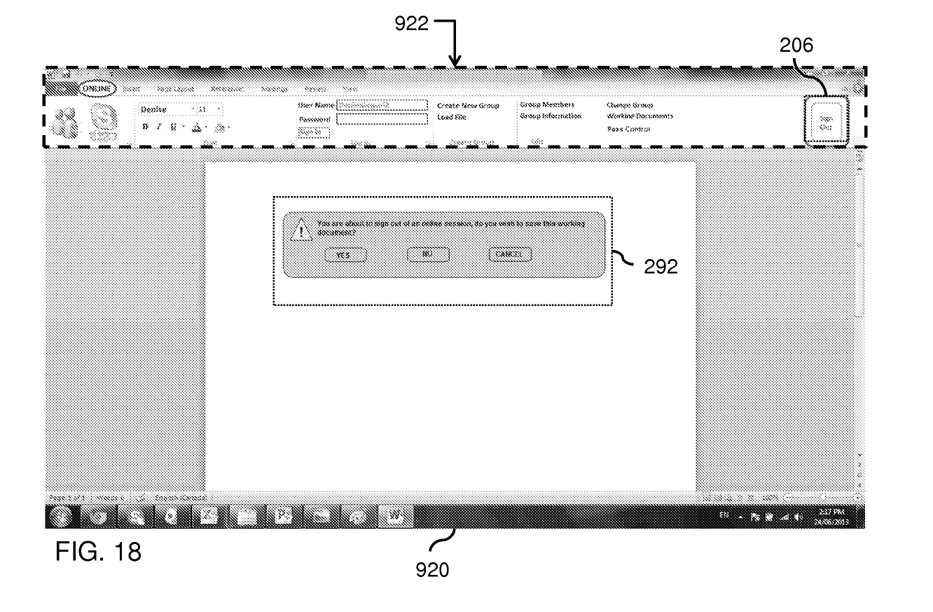

Referring now to FIG. 5, the user interface 920 may also be configured to display a warning field 258. The warning field 258 may appear if a user tries to close a program without saving their document. Here, the user is given the option to ‘Save’, ‘Don't Save’ or ‘Cancel’ their actions. Once a group member saves a file to his/her own computer, they may upload this file via the load file field 216 to continue working on it in the future. In addition, the sign-out window 292 (refer to FIG. 18) may then appear afterward, asking the user if they wish to save the changes they have made on the document to the online working documents file (refer to FIG. 8, the database field 272). The warning field 258 may include a pop-up window. The warning field 258 is configured to appear for the case where a user tries to close the file-manipulation program 918 (word processing application or software) without saving the electronic file 914 (the word processing document). The user is provided with the options to ‘Save’, ‘Don't Save’ or ‘Cancel’ to take or initiate on the electronic file 914. Once the user saves the electronic file 914 to the data processing system 901, the user may use the load file field 216 to upload the electronic file 914 for the purpose of continuing further work (editing) on the electronic file 914 in the future.

Referring now to FIG. 6, the user interface 920 may also be configured to display an online-collaboration field 260 (or window). The online-collaboration field 260 is an example of the electronic file 914 of FIG. 1A. The online-collaboration field 260 is configured to facilitate a collaboration session via the Skype™ online video chat session in response to the user selecting the alternative collaboration-initiation field 202. Up to a maximum of five users may use the Skype™ video chat feature, with the interfacing video feeds appearing on the right-hand side of the electronic file 914 (electronic document) that is being shared and edited. The current controller of the group session would be the one to choose the method of collaboration-initiation field 200 or 202 for the entire group as they have the power to control the other group member's computer screens. If the group members have chosen method of alternative collaboration-initiation field 202 (via the SKYPE™ account, for example) and one or more of the group members do not have access to a webcam, their SKYPE™ system boxes may appear black to the other members but their voice would still be audible to the group members.

Referring now to FIG. 7, the user interface 920 may also be configured to display a file-content field 262 displaying (containing) the contents of electronic file 914 to be edited by way of collaboration. The file-content field 262 is configured to provide (display) the contents of the electronic file 914 of FIG. 1A. The file-content field 262 may include a display of the contents of a word processing document associated with a word-processing software, such as Microsoft Word™ software and the like. The file-content field 262 appears next to the online-collaboration field 264. The online-collaboration field 264 is configured to display an online chat session, whether the chat session is conducted under the Skype™ option initiated by the collaboration-initiation field 200, or under the MSN Messenger™ option initiated by the alternative collaboration-initiation field 202. Collaboration members participating in the collaboration group may view the file-content field 262 showing the contents of the electronic file 914, along with the amendments being initiated by the editing controller of the collaboration group (being made in real time). It may be appreciated that many of the features and pop-up windows and fields may appear in another file-manipulation program 918 that appear to be similar to the fields as shown in the example for Microsoft Word™ software. It may be appreciated that the chat boxes or other tool features may appear to provide a different setup when used with other types of file-manipulation programs. Examples of a file-manipulation program 918 may include Microsoft PowerPoint™ software, Microsoft Excel™ software or others. It is understood that the collaboration tool may be configured for use with any type of electronic file 914 (such as a text file to be edited, a photo to be edited, a video to be edited, etc.). It is understood that any type of electronic file 914 may be edited using the collaboration tool.

The user interface 920 may also be configured to display an online-collaboration field 264 (which may be called a collaboration chat window). The online-collaboration field 264 is configured to operate in response to the members of the collaboration group choosing to activate the collaboration-initiation field 200 of FIG. 1B (the MSN Messenger™ online chat option). In this case, an unlimited number of members of the collaboration group may collaborate using this option. The online-collaboration field 264 appears on the screen to the right of the file-content field 262 being worked on by the members of the collaboration group.

The user interface 920 or the online-collaboration field 264 may also be configured to display a discussion field 266. The discussion field 266 is an example of the electronic file 914 of FIG. 1A. The discussion field 266 is configured to provide an example of the type of collaboration information (text) displayed when the members of the collaboration group are working or collaborating on an electronic file 914 (electronic document), and have chosen the MSN Messenger™ online chat option in response to selecting the collaboration-initiation field 200. The discussion field 266 is configured to display or show the display name of each user above the text message that the group members may type (or enter and send), in response to selecting (clicking) a send field 268. In this way, the remaining members of the collaboration group may view shared comments. The display name of the users may be shown in the display name color as indicated in the display name color field 244 of FIG. 2.

The user interface 920 or the online-collaboration field 264 may also be configured to display the send field 268. The send field 268 is configured to be used in conjunction with the MSN Messenger™ online chat option associated with the collaboration-initiation field 200. The send field 268 is configured to allow a user to type out the text that the user wishes to relay to the other members of the collaboration group that are currently online (in the space provided to the left), and then click the ‘Send’ button to have the collaboration message appear in the discussion field 266 (the chat window) of all on line users.

Referring now to FIG. 8, the user interface 920 may also be configured to display a control-switch field 270. The control-switch field 270 may include a pop-up window. The control-switch field 270 is configured to allow another user to assume control when the editing controller of the collaboration group has been idle for five minutes (or other predetermined time limit). For the case where the editing controller has left their computer idle while a collaboration meeting is in session, or for the case where a networking connection is lost, then the control-switch field 270 may be used. The control-switch field 270 is used for the case where the members of the group remain idle for a maximum of five minutes (or other time limit), during which no productive collaborative work was performed on the electronic file 914. However, the members of the collaboration group are still able to converse via: (A) the Skype™ connection associated with alternative collaboration-initiation field 202 and the online-collaboration field 260, or (B) the MSN Messenger™ connection associated with the collaboration-initiation field 200 and the online-collaboration field 264 (online chat). The control-switch field 270 is used in such a way that once the maximum of five minutes has been reached, the control-switch field 270 is displayed and provides an option to the next user who signed into the collaboration group (behind the group creator) to either accept or decline editing control. If accepted, the next group member may have editing control and can resume work on the electronic file 914. For the case where the group member (collaborator) declines editing control, the next group member to have signed in (behind the group creator) is given the same option, and so on.

The user interface 920 may also be configured to display a database field 272. The database field 272 is configured to allow access to the database of working electronic files that can be saved to a data processing system 901 by each member as many times as they wish and at any point in time. The database field 272 is used to access the database of working documents saved automatically to the server in which the online meeting sessions take place. The document log is time stamped with the date, time and initials of the user in control at that time. Group members may log in and work on the electronic file 914 without the rest of the group present, and to save the electronic file 914. A log is maintained and each entry is time stamped with the date, time and initials of the user saving the electronic file 914 at that time. This feature allows for members to access the electronic file 914 throughout its stages of any work-in-process and to retrieve any lost or omitted work by locating the version of the electronic file 914 by using the time stamp feature. Group members may choose to open up any of the working electronic files and work on that electronic file 914 if so desired.

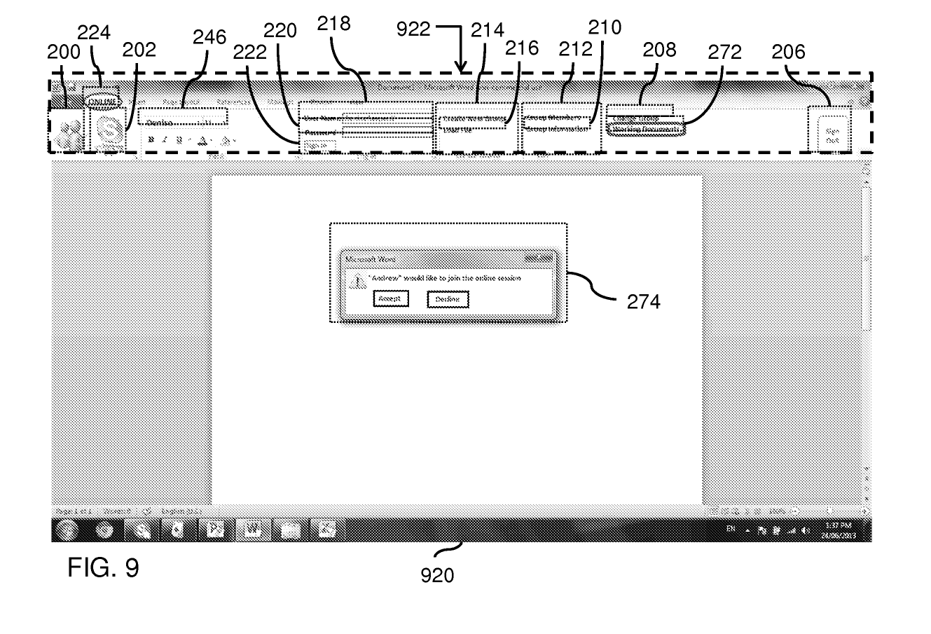

Referring to FIG. 9, the user interface 920 may also be configured to display a request field 274. The request field 274 may include a pop-up window. The request field 274 is configured to show the editing controller of the group meeting that another group member wishes to join the collaboration session (online chat session). In this case, for “Andrew” to have requested to join the collaboration session, the group member would have selected (clicked) a change-group field 208, and then would have chosen a collaboration group from his instance of the list provided by the change-group field 208. The editing controller must then either accept the group member into the group for that group member to actively participate, or decline the request to join.

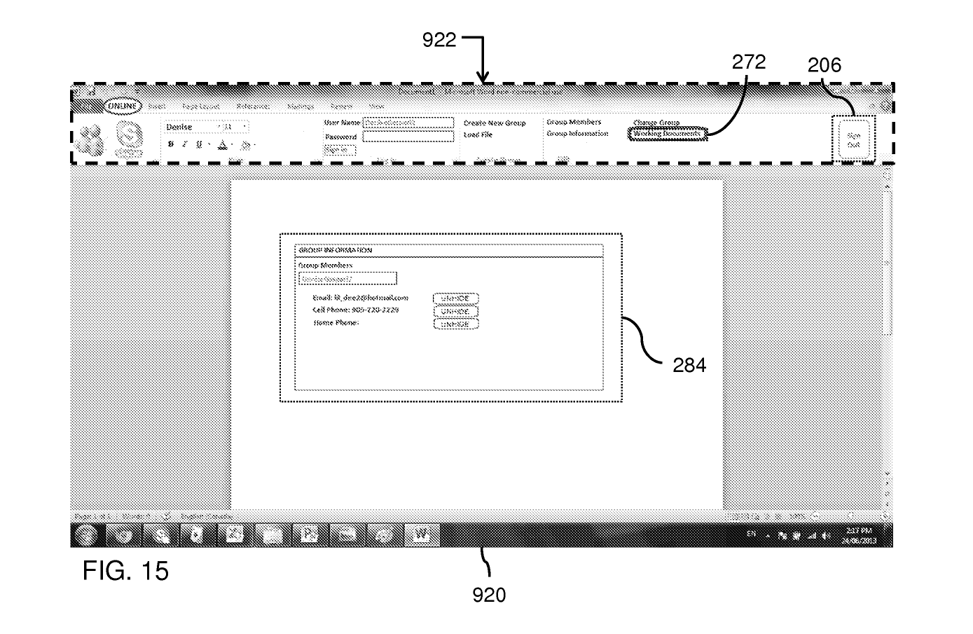

Referring to FIG. 10, the user interface 920 may also be configured to display a contact-information field 276. The contact-information field 276 is configured to store the contact information of each member belonging to the group. This allows other members to click on the group information field 210 and, if made available, they may be able to see contact information in the form of email address(es) and/or phone number(s) for each member. By default, the setting on the user's personal information may be hidden, and once you have accepted the invitation to join a particular group the user can choose whether or not the user wants to unhide this information by clicking collaboration buttons (the unhide button 284 of FIG. 15) or keep the information private. This choice may be available for each particular group the user joins; it may not be a collective decision that applies to all groups that the user is a member thereof. The contact-information field 276 may include a pop-up window. The contact-information field 276 is configured to store the contact information of each member belonging to the collaboration group. The contact-information field 276 is configured to allow other members to select (click) the group information field 210 and, if made available, the other group members are able to see contact information in the form of email addresses, and/or phone numbers for each group member. By default, the setting on the personal information of the user is hidden. Once the user accepts the invitation to join a particular collaboration group, the user can choose whether or not the user wants to “unhide” this personal information or to keep this information private.

Referring to FIG. 11, the user interface 920 may also be configured to display a control option field 278. A control option field 278 is used when the current controller of the group wishes to pass off the control position to another member without leaving the online session. For instance, if another person wishes to take over work on the document for a while, the controller can willingly pass the position of controller to them. Once the current controller has chosen a new controller from the drop-down menu in the pass control button 286 (depicted in FIG. 16) of online group members, a control option field 278 may be displayed to the newly chosen controller, asking whether or not they would like to accept or decline control of the document. Once accepted, that user is now able to make editions to the document and the user who passed off the control can no longer make changes. The control option field 278 may include a pop-up window. The control option field 278 is configured to be used for the case where the current editing controller of the collaboration group wishes to pass off the control position to another group member without leaving the online session. For instance, if another group member wishes to take over editing control of the electronic file 914, the current editing controller can willingly pass the position of the editing controller to another group member. Once the current editing controller has chosen a new editing controller from the collaboration selection field 248 of FIG. 3, the control option field 278 is displayed. The collaboration field is configured to receive an input from the user (the collaborator) as to whether or not the user would like to accept or decline editing control of the electronic file 914. Once accepted, that group member is now able to make amendments to the electronic file 914, and the user who passed off the editing control can no longer make changes to the electronic file 914.

Referring to FIG. 12, the user interface 920 may also be configured to display a collaboration invitation field 280. The collaboration invitation field 280 may include a pop-up window. The collaboration invitation field 280 may also be configured to allow group members to become part of a particular collaboration group. Once the group creator of the collaboration group invites the members (via the create-group field 214), the collaboration invitation field 280 is configured to appear to the users upon signing in, as shown in the user-name field 218 and the user password field 220 and the sign-in field 222 of FIG. 4. The users have the option to either accept or decline the invitation to join the collaboration group (as identified in the create-group field 226 and the group name field 228 of FIG. 1B).

### Operation

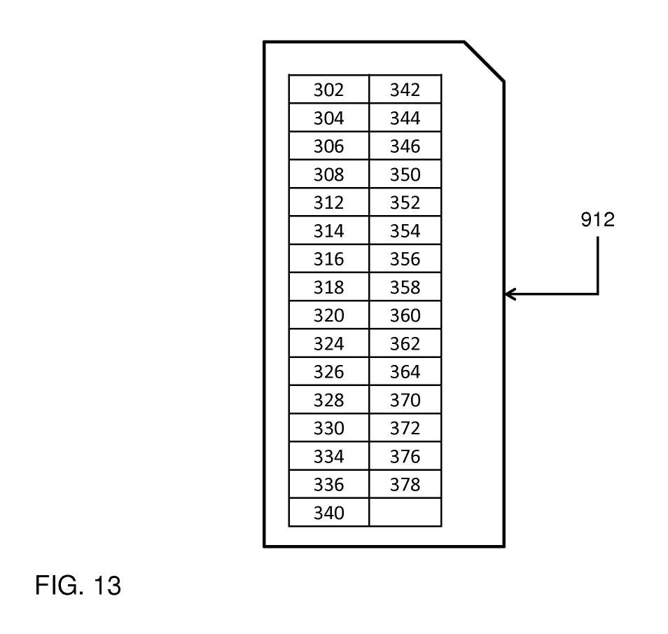

FIG. 13 depicts a schematic example of a method, including the operations of the collaboration program 912 of the apparatus 900 of FIG. 1A.

Operation 302 includes opening an electronic file 914 by using a file-manipulation program 918 (such as the Microsoft Word™ program, the Microsoft Excel™ program, the Microsoft PowerPoint™ program, or any other type of file-manipulation program 918). The user opens an electronic file 914 via a file management program (the file-manipulation program 918). Operational control is passed onto operation 304.

Operation 304 includes (with reference to FIG. 1B) waiting for the user to select (clicks) the on-line toolbar field 224 located in the top toolbar of the user interface 920. Operational control is passed to operation 306.

Operation 306 includes (with reference to FIG. 1B), receiving (via the user-name field 218) a user name, and receiving (via the user password field 220) a password from the user. The user credentials may be created through signing up for a Skype™ account. If the user has an existing account, then the user may use their existing account. Operational control is passed to operation 308.

Operation 308 includes (with reference to FIG. 1B) receiving a user selection (for signing in), from the user via the sign-in field 222. Operational control may proceed to any one of operation 316, operation 312, operation 328, operation 334, operation 354, operation 358, operation 370, or operation 372.

Operation 312 includes (with reference to FIG. 6), waiting for a user selection in which the user activates the online Skype™ chat session (by selecting the alternative collaboration-initiation field 202). To the right of the electronic file 914, the online-collaboration field 260 is made available to the user and shows a list of available members by user name. Members have the ability to communicate through a Skype™ connection with up to four other group members. In accordance with an option (not depicted), next to the online-collaboration field 260, a box may be displayed, which shows the an image of the person who is doing the interfacing with the other images of the people placed on the right hand side in the online-collaboration field 260. Alternatively, for operation 312 (with reference to FIG. 7), the user activates the online MSN Messenger™ chat session via the collaboration-initiation field 200 (depicted in FIG. 6). To the right of the electronic file 914, the online-collaboration field 264 is displayed to the user. The online-collaboration field 264 is configured to coordinate a chat between any number (or instances) of collaborative group members. The user types (enters) what they would like to say to the other group members, then the user may send the message by selecting the send field 268, and then the message (text) appears visible to the other members of the group in the discussion field 266. Operational control may be passed on to any one of the following operations: operation 314, operation 320, operation 326, operation 330, operation 334, operation 336, operation 340, operation 342, operation 344, operation 346, operation 354, operation 358, operation 360, operation 372, or operation 376.

Operation 314 includes (with reference to FIG. 7), the file-content field 262 currently being worked on by the editing controller in the collaboration group that appears to the left of the chat window, and is visible to all online group members (in real time), as all the changes are being made to the electronic file 914 by the editing controller. Operational control may be passed on to operation 316, operation 326, operation 328, operation 330, operation 336, operation 340, operation 342, operation 344, operation 346, operation 352, operation 356, operation 364 (for the case where the users are idle for a predetermined amount of time such as five minutes), or operation 376.

Operation 316 includes (with reference to FIG. 1B) allowing the user to create the collaboration group by using the create-group field 226 in response to the user selecting the create-group field 214. The group name field 228 receives a group name from the group creator (user). The group creator then proceeds to enter values into the add-members field 230. Once the members have been added, the group creator selects (clicks) the finished field 236, and the collaboration program 912 of FIG. 1A then sends an invitation to the group members on the list, so they may either accept or decline to be part of the collaboration group.

Operational control is then passed on to any one of operation 312, operation 318 (depending on the number of group members), operation 324, operation 330, operation 354, or operation 370.

Operation 318 includes (with reference to FIG. 1B) allowing the user to select either the collaboration-initiation field 200 or the alternative collaboration-initiation field 202. There is no limit to the number of members whom a user may add to a collaboration group; however, online chat collaboration may be limited by the type of method used; for instance, the Skype™ option only accommodates up to four members in addition to the original user (for a total of five members). If there are more than five members in a group online at one time, the chat session automatically defaults to the option associated with the collaboration-initiation field 200. Operational control is passed on to any one of operation 312, operation 320, operation 334, or operation 342.

Operation 320 includes (with reference to FIG. 6) having the chat session automatically default to the MSN Messenger™ option associated with the collaboration-initiation field 200 for the case where more than five users in the group are collaborating online at one time; this is shown in the online-collaboration field 260. However, as members leave the session, if the number of members falls below six online members, then the users have the choice of switching to a Skype™ video chat session if they prefer, by selecting the alternative collaboration-initiation field 202 via the on-line toolbar field 224. Operational control is passed on to any one of operation 314, operation 334, operation 342, operation 372, or operation 378.

Operation 324 includes (with reference to FIG. 12) displaying the collaboration invitation field 280 (on sign in for the case where a user has been added to a group by another member); the collaboration invitation field 280 receives an indication from the user as to whether the user has accepted or declined the invitation to join the collaboration group as named by the group creator (as depicted in the group name field 228 of FIG. 1B). Operational control is passed on to any one of operation 336, operation 340, operation 352, or operation 370.

Operation 326 includes (with reference to FIG. 3) displaying, to the user, the username of the user in the collaboration display field 246 displayed under the on-line toolbar field 224. The user then selects the collaboration selection field 248 and then the data processing system 901 displays the status of other group members who are currently listed in the online-members field 250 (or listed in offline-members field 252), regardless of whether the users are in editing control or not. The user also sees the member who is in control via the ‘Editing Controller’ title positioned next to the display/username. Referring to FIG. 3 method of collaboration display field 246, this drop down option may be available for all group members to see. This may allow every member to see who is online, offline, and who is the current controller. Of course, another way may be provided for passing control over to another group member. One solution is that the current controller of the group can select from the item in the tool bar “pass control” which may open a pop-up window allowing the controller to choose a member from a drop down menu which shows the members who are currently online. The “pass control” item in the tool bar may appear greyed out for the other online members who are not in control. Two more images have been created to show the passing of control options. Operational control is passed on to any one of operation 328 (if the user wishes to switch to working with a different group), 330, 344, 346, or 352.

Operation 328 includes (with reference to FIG. 1B) waiting for the user to select the change-group field 208 for the case where the user wishes to sign into a chat session with a particular group or needs to switch groups in order to start work on the electronic file 914 with a different group. A pop-up window listing the users' group(s) is initiated or is displayed, where the user clicks on the particular name of the group, and the user wishes to begin collaboratively interfacing with. By clicking the change group button, the user can sign into a different group if they are working on more than one project at a time with different groups Referring to FIG. 1, the user clicks the change-group field 208 if they need to switch groups in order to start work on a document with a different group. A pop-up window (see FIG. 13) listing the users' group(s) is initiated, where the user clicks on the particular name of the group they wish to begin interfacing with. The change group window 282 is depicted in FIG. 14. The next operation may be operation 372.

Operation 330 includes (with reference to FIG. 3) displaying the name of the editing controller via the collaboration selection field 248. The user who has created the particular group and invited the members to join has control of work on the electronic file 914 by default. The collaboration selection field 248 provides an indication of the name of the editing controller (in brackets beside the display/username of the user who currently has control). Operational control is passed on to any one of operation 312, operation 314, operation 326, operation 336, operation 344 (for the case where the user wants to pass off the control), operation 346, operation 352, or operation 362.

Operation 334 includes (with reference to FIG. 7) waiting for the user to select the option to use MSN Messenger™ chat by selecting the collaboration-initiation field 200 (depicted in FIG. 1B). The online-collaboration field 264 is initiated where the user types their text and sends the text, using the field 268. The message is displayed in the discussion field 266. Operational control is passed on to any one of passed on to operation 336 or operation 342.

Operation 336 includes (with reference to FIG. 2) facilitating the editing of the usernames of the other group members if the user prefers to simplify for clarification or distinguish between two similar usernames by using the group-members field 238, which is initiated by selecting the group-members field 212. The user finds the Group Members listed by username in the username list field 240, and then the user inputs the desired name they wish to have appear during a chat session in the change display name field 242. The user also inputs a specific color for another member's name to appear in, if desired, by using the display name color field 244. Operational control is passed on to any one of operation 312 (MSN Messenger™ software) or operation 334.

Operation 340 includes (with reference to FIG. 10) waiting for the user to select the group information field 210. Once the contact-information field 276 is initiated, users may input their contact information (such as email address, phone numbers and the like), and then choose whether they want to show this information to the other members of a particular collaboration group. Personal information may be hidden by default; however, in the contact-information field 276, the user is able to click an ‘Unhide’ button (the button may also be called a field) to show their information to the online collaborator members. The contact-information field 276 is also where the user can see the unhidden information of other members in the group. Referring to FIG. 10, the user clicks the group information field 210. The contact-information field 276 is initiated, where users can input their contact information (such as email address, phone numbers and the like), and choose whether they want to show this information to the other members of that particular group. Personal information may be hidden by default; however in contact-information field 276 the user is able to click the unhide button 284 (depicted in FIG. 15) in order to show that particular piece of information to everyone in that particular group. The contact-information field 276 is also where the user can see the unhidden information of other members in the group. Once the user has clicked the unhide button 284 on a piece of information, the option to once again HIDE this information may be made available to the user by again clicking that same button. We have created FIG. 15 to show the ‘Hide’/′Unhide′ feature of the contact-information field 276. The “HIDE and UNHIDE” button (in the item 284) is configured to show the personal contact information of the members to the other group members. Each group member has the option to unhide their personal contact information so that it becomes available for the other group members to see. By default, each time a new group is created, each member's personal information is hidden and each item can be unhidden by selecting the option at the group members wishes. Operational control may be passed on to any operation from operation 340.

Operation 342 includes (with reference to FIG. 7) permitting the user to scroll up and down in the online-collaboration field 264 when the conversation of text shown in the discussion field 266 becomes too lengthy to see all at once.

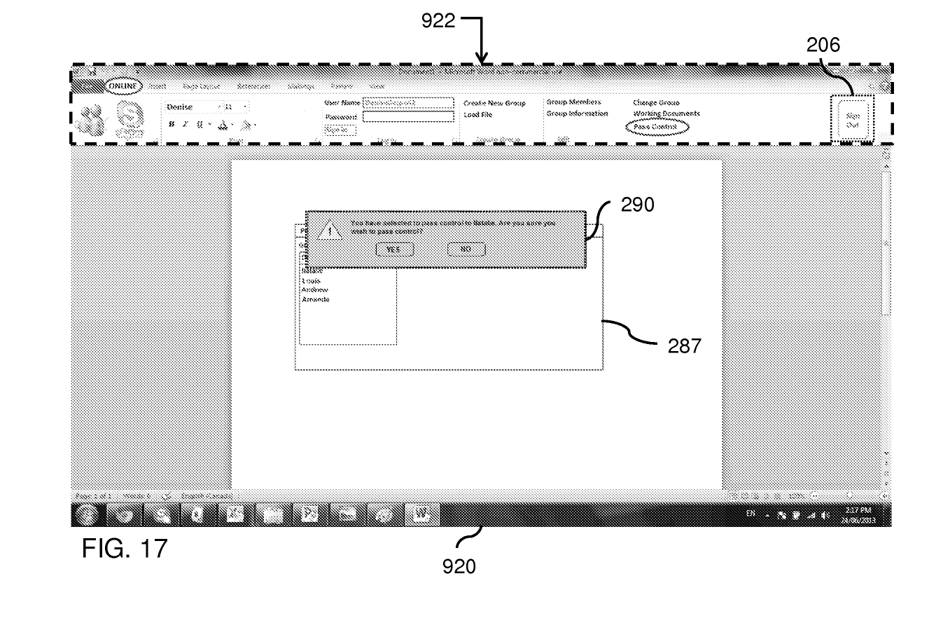

Operation 344 includes (with reference to FIG. 3) allowing the user in control of making changes to the electronic file 914 to pass off the control to another group member via the collaboration selection field 248. The user selects a name from the online-members field 250 (in the drop-down menu), and the control option field 278 (as depicted in FIG. 11) is displayed to on the screen. The new editing controller may either accept or decline control. Once the new editing controller has accepted, the user in control previously may no longer make changes to the electronic file 914. For the controller of the document to pass control, under the online tab, there is a pass-control button 290 (FIG. 17) which, once clicked, initiates a pop-up window listing the online users who are members of the group, where the creator can choose who he/she may pass control off to. Referring to FIG. 17, the user currently in control of editing the document can pass off the control to another group member via the change group window 282 (FIG. 14). The user selects a name from the list of online group members found under their own username, and pass-control window 287 (FIG. 17) appears to ensure that would indeed like to pass of control of the document. The control option field 278 (FIG. 11) is then displayed on the new controller's screen. The new controller must either accept or decline control. Once the new controller has accepted, the user in control previously can no longer make changes to the document. Operational control is passed on to any one of operation 346, operation 348, operation 350, operation 352, operation 360, or operation 362.

Operation 346 includes (with reference to FIG. 3) permitting the user currently in control to view their name at the top of the collaboration selection field 248 under the online-members field 250. The information is greyed-out, with the title ‘Controller’ beside the name, as the user is not able to select herself/himself when trying to pass control off to another member. The person in control may have their name appear at the top of this list with the title “(Controller)” greyed-out beside it. Referring to FIG. 3, the name of the user currently in control is at the top of the collaboration selection field 248 under the online-members field 250. The title ‘(Controller)’ is greyed-out beside it. Go to any operation. This list can be accessed by any member of the group when they are online, to see who else is online, who the current controller is, and who is offline. Or operational control is passed to operation 344.

Operation 348 includes (with reference to FIG. 17), allowing the current controller to select a group member to pass control of the document off to via the change group window 282 (depicted in FIG. 14) and change group window 282 containing the list, the change group window 282 is initiated in order to double-check whether the current controller did indeed want to pass control off to another member. The controller is given the option to agree ‘Yes’ to pass off control, or ‘No’ to remain in control of the document. Once ‘Yes’ is clicked, pass-control window 287 appears to the newly chosen controller. Ability to go to operation 350 (if ‘Yes’ is chosen).

Operation 350 includes (with reference to FIG. 11) allowing the user to receive an offer for editing control of the electronic file 914, as stated in control option field 278. To accept, the user clicks ‘Accept’, and then the user may have the ability to make changes to the electronic file 914. If the user declines, the previous editing controller may remain in control of the electronic file 914. Operational control is passed on to any one of operation 314, operation 326, operation 344, operation 362, or operation 372.

Operation 352 includes (with reference to FIG. 3) allowing the collaborators to view the name of the editing controller; the user in control is the only user in control, as seen in collaboration selection field 248. As depicted, there is only one user in the online-members field 250 with the ‘(Controller)’ status beside their name.

Operation 354 includes (with reference to FIG. 1B) allowing the user to upload an electronic file 914 to be worked on from the data processing system 901 by using the load file field 216. Operational control is passed on to any one of operation 312, operation 314, operation 356, operation 364, or operation 376.

Operation 356 includes (with reference to FIG. 5) allowing the user to save the electronic file 914 using the methods already in place in programs such as Microsoft Word™ software, Microsoft Excel™ software, Microsoft PowerPoint™ software and the like. If the user tries to exit the program without saving the electronic file 914, the warning field 258 is initiated (displayed), and the user may then provide an indication of whether to either ‘Save’, ‘Don't Save’ or ‘Cancel’ the electronic file 914. All users can save the working document to their own computer at any time; the document may have the capability to be saved compatible to the version of the MICROSOFT™ Office system that the user has installed. Referring to FIG. 5, the user saves the document using the methods already in place in programs such as MICROSOFT™ Word program, the MICROSOFT™ Excel program, the MICROSOFT™ PowerPoint program and the like. If the user tries to exit the program without saving the document to their own computer, the warning field 258 may be initiated, asking the user to either ‘Save’, ‘Don't Save’ or ‘Cancel’ the actions. The sign-out window 292 (refer to FIG. 18) may then be initiated, asking the user whether or not they would like to save the changes they have made on the document to the online Working Documents file (accessed by clicking the database field 272 (FIG. 8). Operational control is passed on to any one of operation 360, operation 362, or operation 378.

Operation 358 (referring to FIG. 8) includes allowing the database field 272 to be used to access the database having instances of the working electronic files that may be saved by each group member as many times as they wish and at any point in time they require. Group members can log in and work on the electronic file 914 without the rest of the group being present. This electronic file 914 log is time stamped with the date, time and initials of the user saving their version of the electronic file 914 at that time. This feature allows for members to easily access the electronic file 914 throughout its stages of work-in-process and to retrieve any lost or omitted work by locating the electronic file 914 by using the time stamp feature. Group members can choose to open up any of the working electronic files and work on that electronic file 914. The user in control may also have the ability to save the document to a secure online domain so that group members who missed the session can access it located under “working documents”. Referring to FIG. 8, the user clicks the database field 272 and has access to the saved working documents, which are time stamped with the date, time and initials of the person in control of the session at that particular time.

Operation 360 includes (with reference to FIG. 4) permitting the user that is not in editing control to sign out of an online chat session at any time using the sign-out field 206. Operational control is passed on to any one of operation 356 or operation 378.

Operation 362 includes (with reference to FIG. 4) displaying the sign-out field 254 for the case where the user in editing control tries to sign out using the sign-out field 206 while still in control, and the sign-out field 254 is configured to display to the user a request to pass editing control off to one of the other members currently online as listed in the user-listing field 256. Operational control is passed on to any one of operation 344, operation 346, operation 350, operation 352, operation 356, or operation 378.

Operation 364 includes (with reference to FIG. 8) permitting another user to accept editing control of the electronic file 914 via the control-switch field 270. This means that the previous editing controller has been idle at their instance of a data processing system (not depicted) for a predetermined time (such as five minutes), leaving the other members unable to work on the electronic file 914. By the next user accepting editing control, work on the electronic file 914 is able to resume. If this next user declines when the control-switch field 270 is initiated (displayed), the next user to sign in after them is asked to assume editing control, and so on. Operational control is passed on to any one of operation 314, operation 326, operation 340, operation 344, operation 352, operation 356, operation 362, or operation 376.

Operation 370 includes (with reference to FIG. 12) displaying, to the user who has been invited to join a group by the creator of that group, the collaboration invitation field 280 upon signing in using the user-name field 218, the user password field 220, and the sign-in field 222. The collaboration invitation field 280 receives from the user an indication of whether or not the user may like to accept or decline the invitation to join the particular collaboration group, as named in the create-group field 226 (depicted in FIG. 7). Referring to FIG. 12, for the users who have not created the online domain, all they need to do is sign into their SKYPE™ account using the “Online” tab, and a pop up window may appear asking them to accept the invitation of the user in control. Referring to FIG. 12, the user who has been invited to join a group by the creator of that group may be shown the collaboration invitation field 280 upon signing in using the user-name field 218, the user password field 220, and the sign-in field 222. This collaboration invitation field 280 asks the user whether or not they would like to accept or decline the invitation to join the particular group, as named in the create create-group field 226 using the create-group field 214. If they are already an active member of a group(s), the sign-in window 294 (FIG. 19) may be initiated, asking the user to select the group they wish to begin interfacing with. Operational control is passed on to any one of operation 326, operation 336, operation 340, operation 342, operation 350, operation 360, operation 376, or operation 378.

Operation 372 includes (with reference to FIG. 9) receiving, from the user, in control of the session, via the request field 274, whether or not the user may accept a group member into the online chat session. Once accepted, that user is an active member in either the online-collaboration field 260 (depicted in FIG. 6) or the online-collaboration field 264 (depicted in FIG. 7). The editing controller decides which method is used by selecting (clicking) either the collaboration-initiation field 200 or the alternative collaboration-initiation field 202, unless there are more than five people online, at which time the chat session may default to online-collaboration field 264. Operational control is passed on to any one of operation 312, operation 314, operation 318, operation 320, operation 326, operation 328 (if signed into the wrong group, for example), operation 336, operation 340, operation 342, operation 350, operation 354, operation 356, operation 358, operation 360, or operation 364.

Operation 376 includes (with reference to FIG. 7) displaying, to the user, any changes made on the file-content field 262, in real time, by the editing controlling of the collaboration group. Operational control is passed on to any one of operation 314, operation 326, operation 330, operation 336, operation 340, operation 342, operation 344, operation 356, or operation 364.

Operation 378 includes a signing out from a collaboration group currently in an online session. A pop-up window may appear asking if the group member wishes to save the working document before signing out, with “yes”, “no”, or “cancel” as options. Permitting the last user to sign out of the online chat session to view a sign-out window 292 (FIG. 18), which request input from the user whether the user would like to end the chat session. Operational control is passed on to operation 356.

When group members sign into Microsoft documents, they may be asked to select the group in which they would like to sign into. As an option, a pop-up screen can be provided to ask the user to choose from a list. Once they have selected a group, the MICROSOFT™ chat system may be the immediate default every time members sign in and if they wish to use SKYPE™ system they just need to click the option to use the SKYPE™ system. An image has been created to show when a member signs into word documents of how to select a group. Once users sign in, the user may start a chat session. The user may click the change-group field 208 to see their list of group(s) and choose from there. Next step is obtaining approval to join the chat session by the controller; operational control may be transferred to operation 372.

### Data Processing System

According to one option, the data processing system 901 includes controller-executable instructions configured to operate the data processing system 901 in accordance with the description provided above. The data processing system 901 may use computer software, or just software, which is a collection of computer programs (controller-executable instructions) and related data that provide the instructions for instructing the data processing system 901 what to do and how to do it. In other words, software is a conceptual entity that is a set of computer programs, procedures, and associated documentation concerned with the operation of the data processing system 901, also called a data-processing system. Software refers to one or more computer programs and data held in a storage assembly (a memory module) of the controller assembly for some purposes. In other words, software is a set of programs, procedures, algorithms and its documentation. According to another option, the data processing system 901 includes application-specific integrated circuits configured to operate the data processing system 901 in accordance with the description provided above. It may be appreciated that an alternative to using software (controller-executable instructions) in the data processing system 901 is to use an application-specific integrated circuit. The data processing system 901 may be a physical computer (a computer hardware system) dedicated to run one or more services (as a host), to serve the needs of the users of other computers on a network. The data processing system 901 may also be a virtual machine (VM). The virtual machine is a simulation of a computer system (abstract or real) that is usually different from the target computer system (where it is being simulated on). Virtual machines may be based on the specifications of a hypothetical computer or emulate the architecture and functioning of a real-world computer. The virtual machine is a software implementation of the physical computer system that executes programs like a physical machine. Virtual machines are separated into two major categories, based on their use and degree of correspondence to any real machine. A system virtual machine provides a complete system platform, which supports the execution of a complete operating system (OS). These usually emulate an existing architecture, and are built with either the purpose of providing a platform to run programs where the real hardware is not available for use (for example, executing software on otherwise obsolete platforms), or of having multiple instances of virtual machines lead to more efficient use of computing resources, both in terms of energy consumption and cost effectiveness (known as hardware virtualization, the key to a cloud computing environment), or both. In contrast, a process virtual machine (also, language virtual machine) is designed to run a single program, which means that it supports a single process. Such virtual machines are usually closely suited to one or more programming languages and built with the purpose of providing program portability and flexibility (amongst other things). An essential characteristic of a virtual machine is that the software running inside is limited to the resources and abstractions provided by the virtual machine—it cannot break out of its virtual environment. Depending on the computing service that the data processing system 901 offers, the data processing system 901 may be a database server, a file server, a mail server, a print server, a web server, a gaming server, or some other kind of server. In the context of client-server architecture, the data processing system 901 is a computer program running to serve the requests of other programs, the clients. Thus, the data processing system 901 performs some computational task on behalf of clients. The clients either run on the same computer or connect through the network. In the context of Internet Protocol (IP) networking, the data processing system 901 is a program that operates as a socket listener. Servers often provide essential services across a network, either to private users inside a large organization or to public users via the Internet.

FIG. 14 depicts an example of a change group window 282 in the user interface 920.

The change group window 282 is used to allow the user to change to a different group if they have already signed in and wish to work on another document with another group. Once the change-group field 208 (FIG. 1) is clicked, the change group window 282 of FIG. 14 is initiated. The current group in which the user is working appears in the top toolbar, beside which a drop-down arrow allows them to see the group name(s) of their other group(s), and click on which one they would like to start an online session with. Once a new group is selected, request field 274 (FIG. 9) appears to the other online members of that group to accept you as a member, and the process for signing out of the user's currently-active group (the old group) follows the sequence according to FIG. 4 (the sign-out field 254), FIG. 5 (the warning field 258) and FIG. 17 (Item 290).

FIG. 15 depicts an example of an unhide button 284 in the user interface 920.

The unhide button 284 is configured to allow the user to unhide each aspect (whether the aspect if an e-mail address, and/or a phone number, etc.) of their personal information by clicking the unhide button 284 next to each field in the group information pop-up window (otherwise known as the contact-information field 276). By default, the setting on each user's personal information is hidden, and once the invitation to join a particular group has been accepted, the choice of whether or not to unhide this information by clicking the unhide button 284 is given. This choice is available for each particular group the user joins; it may not be a collective decision that applies to all groups they are a member of.

FIG. 16 depicts an example of a pass control button 286 in the user interface 920.

The pass control button 286 is used by the current controller to give control of the document to another member of the group if they so wish. Once clicked, the pass control button 286 initiates a pass-control window 287 which contains a list of the members of the group who are currently online. If you are not the user in control, the pass control button 286 is greyed-out on the user's screen, as only the current controller has the ability to pass control off to another member.

FIG. 16 depicts an example of a pass-control window 287 in the user interface 920.

The pass-control window 287 is initiated by clicking the pass control button 286, and is only accessible to the current controller of the group. The pass-control window 287 shows the username at the top of the group members list with a drop-down arrow beside where, if clicked, a list of the online members of the group appears and allows you to click on the name of the member you wish to pass control off to. If you have changed the usernames to a more convenient display name, this name is what appears in the list. If you have not changed the username, their original username would appear here by default. Once a name is selected, a pop-up window (refer to FIG. 17, Item 290) may appear asking you to confirm whether you would indeed like to pass control off to this user or not.

FIG. 17 depicts an example of a pass-control button 290 in the user interface 920.

The pass-control button 290 is used to determine whether the current controller would in fact like to pass control to another user or not. Once they have selected a user's name from the drop-down list in the ‘Pass Control’ pop-up window (the unhide button 284 of FIG. 15), the pass-control window 287 in FIG. 16 ensures that control is not being passed by accident, and gives the current controller another chance to decline passing off control, or to agree to pass off control. Once ‘YES’ is selected, a pop-up window (refer to FIG. 11, control option field 278) may appear on the new controller's screen asking them to either accept or decline control of the document. Once they have accepted, the user previously in control may no longer be able to make changes to the document.

FIG. 18 depicts an example of a sign-out window 292 in the user interface 920.

The sign-out window 292 appears to the user before signing out, to ask whether or not they would like to save the changes they have made on the document to the online Working Documents file (accessed by clicking the database field 272, the Working Documents button). The user is then given the option to answer ‘Yes’, ‘No’ or to ‘Cancel’ their actions. In addition, if a user tries to close a program without saving the document to their own computer, the warning field 258 (FIG. 5) appears before sign-out window 292, giving them the option to either ‘Save’ the document, ‘Don't Save’ the document or to ‘Cancel’ their actions. Once a group member saves a file to his/her own computer, they may be able to upload this file via the collaboration button ‘Load File’ (load file field 216) to continue working on it in the future.

FIG. 19 depicts an example of a sign-in window 294 in the user interface 920.

A sign-in window 294 is used to allow the user to select the group they wish to partake in an online session with, if belonging to more than one group. After the groups have been initially set up, upon sign-in, this pop-up window appears and the user can click on the group name to which they wish to belong to at this particular time. The list of groups to which a particular user belongs is saved individually to their username/password, so that when they sign into the online collaboration using a different program (for example, Microsoft™ Excel™ spreadsheet program, and the like, instead of a word processing program), they are able to access all of their groups with ease.

It may be appreciated that the assemblies and modules described above may be connected with each other as may be needed to perform desired functions and tasks that are within the scope of persons of skill in the art to make such combinations and permutations without having to describe each and every one of them in explicit terms. There is no particular assembly, or components that are superior to any of the equivalents available to the art. There is no particular mode of practicing the disclosed subject matter that is superior to others, so long as the functions may be performed. It is believed that all the crucial aspects of the disclosed subject matter have been provided in this document. It is understood that the scope of the present invention is limited to the scope provided by the independent claim(s), and it is also understood that the scope of the present invention is not limited to: (i) the dependent claims, (ii) the detailed description of the non-limiting embodiments; (iii) the summary; (iv) the abstract; and/or, (v) the description provided outside of this document (that is, outside of the instant application as filed, as prosecuted, and/or as granted). It is understood, for the purposes of this document, that the phrase “includes” is equivalent to the word “comprising.” It is noted that the foregoing has outlined the non-limiting embodiments (examples). The description is made for particular non-limiting embodiments (examples). It is understood that the non-limiting embodiments are merely illustrative as examples. Other modifications and alterations may be used in the design and manufacture of other embodiments according to the present invention without departing from the spirit and scope of the invention, which is limited only by the accompanying claims.

We claim:

1. An apparatus for user collaboration, comprising:
a data processing system being configured to interface with an input device, an output device, and a network connection, and the data processing system including:
a processor assembly, and
a non-transitory machine-readable storage medium operatively coupling to the processor assembly, and tangibly embodying:
an electronic file; and
a set of processor-executable instructions including a collaboration program being configured to:
display a user interface via the output device, and the user interface being configured to display, at least in part, an output of a file-manipulation program via the output device, the file-manipulation program being configured to manipulate the electronic file; and
manipulate the user interface in such a way that the user interface displays a collaboration-initiation field to the user via the output device.

2. The apparatus of claim 1, wherein:
the collaboration program is configured to:
be integrated with the file-manipulation program, and the file-manipulation program is configured to facilitate user amendment of the electronic file in response to user commands received via the input device of the data processing system.

3. The apparatus of claim 2, wherein:
the collaboration program is configured to:
display an online user collaboration session from within the electronic file as displayed by the file-manipulation program to the user.

4. The apparatus of claim 3, wherein:
the collaboration program is configured to:
display the online user collaboration session from within the electronic file as displayed by the file-manipulation program to the user in such a way that options of the online user collaboration session are user visible and user accessible.

5. The apparatus of claim 4, wherein:
the collaboration program is configured to:
communicate, via the network connection, the electronic file undergoing amendment to each instance of the data processing system associated with each collaborative member currently involved in the online user collaboration session, via the network connection, in such a way that each instance of the data processing system of each online collaborative member currently involved in the online user collaboration session receives communications from the collaboration program.

6. The apparatus of claim 5, wherein:
the collaboration program is configured to:
facilitate editing control of the electronic file by only one collaborative member of collaborative members in such a way as to reduce potential confusion of other collaborative members making amendments to the electronic file, while other online collaborative members review the electronic file.

7. The apparatus of claim 6, wherein:
the collaboration program is configured to:
save versions of the electronic file at various points in time in such a way that prior amended versions the electronic file is reviewable by collaborative members, and the electronic file is retrievable for viewing of various saved versions of the electronic file.

8. The apparatus of claim 7, wherein:
the collaboration program is configured to:
facilitate sign in of a collaboration member into the online user collaboration session by allowing the collaboration member to sign in and then allow user viewing of contents of the electronic file being displayed by the file-manipulation program, and the online user collaboration session permits collaboration members to collaborate in real-time.

9. The apparatus of claim 1, wherein:
the collaboration program is configured to:
display, via the user interface:
contents of the electronic file being controlled for amendment by a selected collaboration member of a collaboration group, and also being disabled for amendment by remaining collaboration members; and
contents of an exchange of user comments associated with an online user collaboration session in which user comments are received from the collaboration members participating in the online user collaboration session, and user comments facilitate collaborative amendment of the contents of the electronic file.

10. The apparatus of claim 1, wherein:
the collaboration program is configured to:
display, via the user interface:
contents of the electronic file undergoing user amendment;
an online user collaboration session involving collaboration members of a user-collaboration group, and the online user collaboration session includes facilitation of a virtual meeting conducted in a communication mode; and
a collaboration tool bar.

11. The apparatus of claim 1, wherein:
the collaboration program is configured to:
display a collaboration tool bar, and
an amendment tool bar of the file-manipulation program configured to amend contents of the electronic file.

12. The apparatus of claim 1, wherein:
the collaboration program is configured to:
display, via the output device in the user interface, an online user collaboration session involving online collaboration members of a user-collaboration group.

13. The apparatus of claim 1, wherein:
the collaboration program is configured to:
assist user setup of a user-collaboration group having identification of collaboration members.

14. The apparatus of claim 1, wherein:
the collaboration program is configured to:
facilitate sending invitations to collaboration members identified by a user-collaboration group in such a way that an online user collaboration session involves at least some of the collaboration members.

15. The apparatus of claim 1, wherein:
the collaboration program is configured to:
selectively identify a collaboration member from a user-collaboration group to be an editing controller in charge of making electronic amendments to the electronic file while an online user collaboration session is active.

16. The apparatus of claim 1, wherein:
the collaboration program is configured to:
permit only a collaboration member being selected as an editing controller to make electronic amendments to the electronic file.

17. The apparatus of claim 1, wherein:
the collaboration program is configured to:
pass a role of an editing controller from a collaboration member currently acting as the editing controller to another collaboration member from a user-collaboration group to be the editing controller in command of making electronic amendments to the electronic file while an online user collaboration session is active.

18. The apparatus of claim 1, wherein:
the collaboration program is configured to:
pass a role as an editing controller to only one collaboration member at a time.

19. The apparatus of claim 1, wherein:
the collaboration program is configured to:
permit one, and only one, of collaboration members to act as an editing controller.

20. The apparatus of claim 1, wherein:
the collaboration program is configured to:
facilitate an online user collaboration session by using real-time collaboration communication between collaboration members.

21. The apparatus of claim 1, wherein:
the collaboration program is configured to:
not be integrated with the file-manipulation program, and the file-manipulation program is configured to facilitate user amendment of the electronic file in response to user commands received via the input device of the data processing system.

22. The apparatus of claim 1, wherein:
the collaboration program is configured to:
integrate a virtual collaboration meeting in which features of the file-manipulation program are user visible and user assessable.

23. The apparatus of claim 1, wherein:
the collaboration program is configured to:
display the electronic file from within the file-manipulation program and a collaboration tool bar, in which the collaboration tool bar is configured to facilitate initiation of a collaboration session amongst collaboration members of a collaboration group.

24. The apparatus of claim 1, wherein:
the collaboration program is configured to:
save historical versions of the electronic file to a file-version database by at least any one option of:
at predetermined time intervals; and
whenever a file-save request is received by the collaboration program from a collaboration member.

25. An apparatus, comprising:
a non-transitory machine-readable storage medium tangibly embodying:
a collaboration program, and the non-transitory machine-readable storage medium being configured to be used in a process of installation of the collaboration program onto a non-transitory machine-readable storage medium of a data processing system, and the collaboration program being configured to:
display a user interface via an output device, and the user interface being configured to display, at least in part, an output of a file-manipulation program via the output device, the file-manipulation program being configured to manipulate an electronic file; and
manipulate the user interface in such a way that the user interface displays a collaboration-initiation field to the user via the output device.

26. A method of user collaboration, comprising:
displaying a user interface via an output device of a data processing system, and the user interface being configured to display, at least in part, an output of a file-manipulation program via the output device, the file-manipulation program being configured to manipulate an electronic file; and
manipulating the user interface in such a way that the user interface displays a collaboration-initiation field to the user via the output device.

27. The method of claim 26, further comprising:
integrating with the file-manipulation program, and the file-manipulation program is configured to facilitate user amendment of the electronic file in response to user commands received via an input device of the data processing system.

28. The method of claim 27, further comprising:
displaying an online user collaboration session from within the electronic file as displayed by the file-manipulation program to the user.

29. The method of claim 28, further comprising:
displaying the online user collaboration session from within the electronic file as displayed by the file-manipulation program to the user in such a way that options of the online user collaboration session are user visible and user accessible.

30. The method of claim 29, further comprising:
communicating, via a network connection, the electronic file undergoing amendment to each instance of the data processing system associated with each collaborative member currently involved in the online user collaboration session, via the network connection, in such a way that each instance of the data processing system of each online collaborative member currently involved in the online user collaboration session receives communications.

31. The method of claim 30, further comprising:
facilitate editing control of the electronic file by only one collaborative member of collaborative members in such a way as to reduce potential confusion of other collaborative members making amendments to the electronic file, while other online collaborative members review the electronic file.

32. The method of claim 31, further comprising:
saving versions of the electronic file at various points in time in such a way that prior amended versions the electronic file is reviewable by collaborative members, and the electronic file is retrievable for viewing of various saved versions of the electronic file.

33. The method of claim 32, further comprising:
facilitating sign in of a collaboration member into the online user collaboration session by allowing the collaboration member to sign in and then allow user viewing of contents of the electronic file being displayed by the file-manipulation program, and the online user collaboration session permits collaboration members to collaborate in real-time.

34. The method of claim 26, further comprising:
displaying, via the user interface:
contents of the electronic file being controlled for amendment by a selected collaboration member of a collaboration group, and also being disabled for amendment by remaining collaboration members; and
contents of an exchange of user comments associated with an online user collaboration session in which user comments are received from the collaboration members participating in the online user collaboration session, and user comments facilitate collaborative amendment of the contents of the electronic file.

35. The method of claim 26, further comprising:
displaying, via the user interface:
contents of the electronic file undergoing user amendment;
an online user collaboration session involving collaboration members of a user-collaboration group, and the online user collaboration session includes facilitation of a virtual meeting conducted in a communication mode; and
a collaboration tool bar.
